(19) United States
(12) Patent Application Publication
(10) Pub. No.: US 2008/0051531 A1
(43) Pub. Date: Feb. 28, 2008

(54) GAS PHASE PROCESS FOR POLYMERS WITH GROUP 4 METAL COMPLEX CATALYST ADDITION

(75) Inventors: Xinlai Bai, Piscataway, NJ (US); Maria A. Apecetche, Bridgewater, NJ (US); Kevin J. Cann, Rocky Hill, NJ (US); David L. Ramage, Lake Jackson, TX (US); Natarajan Muruganandam, Hillsborough, NJ (US); Ardenhu Sen, Somerset, NJ (US); Matthew J. Fedec, Lake Jackson, TX (US); Woo Min Song, High Bridge, NJ (US); David M. Rebhan, Pittsburgh, PA (US); Albert L. Widmar, Dilltown, PA (US)

Correspondence Address: The Dow Chemical Company, Intellectual Property Section, P.O. Box 1967, Midland, MI, 48641-1967, US

(73) Assignee: Union Carbide Chemicals & Plastics Technology Corporation, Midland, MI (US)

(21) Appl. No.: 11/852,387

(22) Filed: Sep. 10, 2007

Related U.S. Application Data
(63) Continuation of application No. 10/468,978, filed on Aug. 22, 2003.
(60) Provisional application No. 60/278,960, filed on Mar. 27, 2001.

(51) Int. Cl. C08F 2/34

(52) U.S. Cl. 526/74

(57) ABSTRACT

A process for producing polymer particles in a gas phase polymerization reaction using a group 4 metal complex containing at least one cyclic ligand containing delocalized π-electrons and optionally a flow aid.

The present invention relates to a gas-phase polymerization employing unsupported group 4 metal catalysts. More particularly the present invention relates to such a process for forming polymers under temperature and other conditions of formation where self-adhesion of polymer particles, thereby leading to agglomerate formation, is a problem.

Gas phase reactions for the production of olefin polymers are well known in the art. Such gas phase reactions are typically carried out by fluidized bed, stirred or paddle-type reaction systems, and the like, as described in, for example, U.S. Pat. Nos. 4,588,790, 3,256,263, 3,625,932 and elsewhere.

Gas phase processes for polymerization of olefins, including the use of metallocenes has been disclosed in U.S. Pat. Nos. 4,543,399, 4,588,790, 5,453,471 and elsewhere. Numerous problems arise when applying such processes to the formation of elastomers and other low melting point polymers, especially diene based polymers. For example, use of condensation agents can result in solubilization of the polymer and loss of desired particle morphology.

Methods for introducing liquid, that is, unsupported, catalysts into gas phase polymerizations have been previously disclosed in U.S. Pat. No. 5,317,036. Improved techniques include use of perpendicular spray nozzles (U.S. Pat. No. 6,075,101), ultra sonication and protection of the spray with a gas shroud (U.S. Pat. No. 6,150,478), use of a non-volatile solvent (U.S. Pat. No. 5,744,556), and protecting the spray from contacting the polymer bed by means of a lean zone (U.S. Pat. No. 5,693,727).

Gas phase polymerization of sticky polymers, that is, polymers having a tendency to agglomerate at the conditions used for their formation, wherein a “flow aid” is incorporated in the polymerization mixture to prevent such agglomeration are disclosed in U.S. Pat. No. 5,162,464, U.S. Pat. No. 5,200,477 and elsewhere. Examples of such known flow aids include, carbon black, clay, and silicone treated derivatives thereof, especially carbon black having a surface coating of a polysiloxane, such as a dihydrocarbylpolydimethylsiloxane. The utilization a conventional Ziegler-Natta or vanadium based catalyst compositions in such polymerizations has been marked by relatively low polymerization temperatures and a resulting product that is lacking in a desired level of homogeneity and randomness as to comonomer incorporation. Low process temperatures are generally undesired due to reduced conversion efficiency and consequent increased costs of operation. Improved homogeneity and random comonomer incorporation is generally desired due to improved product physical properties.

Previously known elastomeric diene-ethylene copolymers prepared by the use of the foregoing prior art processes may possess an undesirably high crystallinity due to the presence of ethylene homopolymer segments as well as an unacceptable degree of comonomer block polymer content. Such polymers may result either from an unacceptable level of α-olefin and/or diene incorporation due to catalyst inefficiency or due to the catalyst's proclivity towards comonomer block formation (blockiness). The presence of comonomer blocks in the polymer can be determined through ¹³C NMR triad analysis. As used herein, the term “homogeneous” refers to polymer products containing a low degree of crystallinity (substantially amorphous) and/or low comonomer block formation. Generally, copolymers containing higher levels of comonomer block formation have reduced physical properties, especially tensile properties, such as stress-strain and tear resistance. Polymers containing higher crystallinity are also characterized by reduced elastomeric properties, particularly low temperature impact properties. For certain applications, particularly those requiring good tensile properties or impact resistance, such non-homogeneous polymers accordingly are unacceptable.

Finally, there is a continuing desire in the industry for a polymerization process for forming polymers, especially homopolymers and copolymers of diene monomers having a relatively high molecular weight. Such high molecular weight polymers have desirable properties for certain applications, such as roofing materials, where improved stress-strain properties, tear resistance, and Shore “A” hardness properties are important. One measure used in the industry to rate such polymers is viscosity, particularly Mooney viscosity. Polymers having higher molecular weight generally possess higher Mooney viscosity. It would be especially desirable to provide polymeric products, especially elastomers having Mooney viscosities greater than 100, preferably greater than 150, most preferably greater than 200, in a process operating at high efficiency.

Despite the forgoing known processes, it would be desirable to provide a gas-phase polymerization process for forming polymers of olefin monomers, especially low melting, “sticky” polymers, such as diene containing homopolymers and copolymers under conditions wherein a flow aid is employed and utilizing unsupported, group 4 metal complexes as one catalyst component.

It would furthermore be desirable to provide a process for preparing the foregoing polymers, preferably from a monomer mixture comprising a conjugated or non-conjugated diene, and optionally ethylene and/or one or more α-olefins, and wherein decreased consumption of catalyst components and, in the case of diene containing copolymers, increased homogeneous incorporation of said diene or α-olefin in the resulting polymer is achievable.

A further desirable achievement would be a polymerization process for preparing polymers from a monomer mixture, especially a monomer mixture comprising a conjugated or non-conjugated diene, ethylene and optionally one or more higher α-olefins, wherein polymers, especially elastomeric polymers having improved properties, such as reduced odor may be attained.

A final desirably goal is a gas phase process capable of preparing polymers such as the foregoing in greater efficiency by use of higher operating temperatures, but without concomitant particle agglomeration.

According to the present invention there is now provided a process for producing polymer particles in a gas phase polymerization reaction comprising:

a) introducing one or more polymerizable monomers into a reactor operating under gas phase polymerization conditions, preferably at a temperature of at least 50° C., more preferably at least 60° C., most preferably from 65 to 90° C.;

b) introducing into said reactor a material that is capable of preventing substantial formation of polymer particle agglomerates (flow aid);

c) introducing a polymerization catalyst composition comprising a group 4 metal complex containing at least one cyclic ligand containing delocalized 1-electrons and a cocatalyst therefor, preferably in liquid form, into said reactor, and preferably into the reaction zone of the reactor; said steps a), b) and c) occurring in any order, two together or all three simultaneously; and

d) withdrawing a polymer product from the reactor in the form of free flowing polymer particles, preferably said polymer product having a Mooney viscosity of at least 100, more preferably at least 150, most preferably at least 200.

In one embodiment of the foregoing invention, there is provided a process for producing an elastomeric polymer in particle form in a gas phase polymerization reaction comprising:

a) introducing one or more conjugated or non-conjugated diene monomers having from 4 to 20 carbon atoms, optionally ethylene, and further optionally one or more C₃₋₈ α-olefins into a reaction zone operating under gas phase polymerization conditions, preferably at a temperature of at least 50° C., more preferably at least 60° C., most preferably from 65 to 90° C.;

b) introducing into said reaction zone a solid, particulate material comprising carbon black, said particulate material being capable of preventing substantial formation of polymer particle agglomerates;

c) introducing a polymerization catalyst comprising a group 4 metal complex containing at least one cyclic ligand containing delocalized π-electrons in liquid form into said reaction zone; and

d) withdrawing free flowing polymer particles from said reaction zone, preferably said polymer having a Mooney viscosity of at least 100, more preferably at least 150, most preferably at least 200.

In a further embodiment of the present invention, there is provided a process for producing an elastomeric polymer in particle form in a gas phase polymerization reaction comprising:

a) introducing one or more conjugated or non-conjugated diene monomers having from 4 to 20 carbon atoms, optionally ethylene, and further optionally one or more C₃₋₈ α-olefins into a reaction zone operating under gas phase polymerization conditions at a temperature of at least 50° C., preferably at least 60° C., more preferably from 65 to 90° C.;

b) optionally introducing into said reaction zone a solid, particulate material capable of preventing substantial formation of polymer particle agglomerates;

c) introducing a polymerization catalyst comprising a group 4 metal complex containing at least one cyclic ligand containing delocalized π-electrons into said reaction zone; and

d) withdrawing free flowing polymer particles from said reaction zone, said polymer preferably having a Mooney viscosity of at least 100, more preferably at least 150, most preferably at least 200.

In another embodiment of the present invention, there is provided a process for producing an elastomeric polymer in particle form in a gas phase polymerization reaction, said polymer having a Mooney viscosity of at least 100, preferably at least 150, more preferably at least 200, comprising:

a) introducing one or more conjugated or non-conjugated diene monomers having from 4 to 20 carbon atoms, optionally ethylene, and further optionally one or more C₃₋₈ α-olefins into a reaction zone operating under gas phase polymerization conditions, preferably at a temperature of at least 50° C., more preferably at least 60° C., most preferably from 65 to 90° C.;

b) optionally introducing into said reaction zone a solid, particulate material capable of preventing substantial formation of polymer particle agglomerates;

c) introducing a polymerization catalyst comprising a group 4 metal complex containing at least one cyclic ligand containing delocalized π-electrons into said reaction zone; and

d) withdrawing free flowing polymer particles from said reaction zone.

In another embodiment of the present invention, there is provided a process for producing an elastomeric polymer in particle form in a gas phase polymerization reaction, said polymer having crystallinity of less than 1.5 percent, preferably less than 1.1 percent, most preferably less than 1.0, 0.5 or even 0.1 percent, comprising:

a) introducing one or more conjugated or non-conjugated diene monomers having from 4 to 20 carbon atoms, ethylene, and optionally one or more C₃₋₈ α-olefins into a reaction zone operating under gas phase polymerization conditions, preferably at a temperature of at least 50° C., preferably at least 60° C., more preferably from 65 to 90° C.;

b) optionally introducing into said reaction zone a solid, particulate material capable of preventing substantial formation of polymer particle agglomerates;

c) introducing a polymerization catalyst comprising a group 4 metal complex containing at least one cyclic ligand containing delocalized π-electrons into said reaction zone; and

d) withdrawing free flowing polymer particles from said reaction zone, said polymer preferably having a Mooney viscosity of at least 100, more preferably at least 150, most preferably at least 200.

In a final embodiment of the present invention there is provided a process for producing polymer from one or more conjugated or non-conjugated diene monomers having from 4 to 20 carbon atoms, optionally ethylene, and further optionally one or more C₃₋₈ α-olefins in a gas fluidized bed reactor having a reaction zone containing a bed of growing polymer particles, a lower gas diffusion zone, an upper reduced gas velocity zone, a gas inlet into said gas diffusion zone, and a gas outlet above said reduced gas velocity zone which comprises:

a) continuously passing a gaseous stream containing said monomer or monomers through said gas diffusion zone and into said reaction zone operating at a temperature of at least 50° C., preferably at least 60° C., more preferably from 65 to 90° C., with an upward velocity sufficient to maintain said particles in a suspended and gas fluidized condition;

b) introducing a catalyst comprising a group 4 metal complex containing at least one cyclic ligand containing delocalized π-electrons, preferably in the liquid state into said reaction zone;

c) withdrawing polymer product from said reaction zone, said polymer preferably having a Mooney viscosity of at least 100, more preferably at least 150, most preferably at least 200;

d) continuously withdrawing a stream of unreacted gases comprising said monomer or monomers from said reaction zone, compressing and cooling said stream; and

e) continuously introducing said stream into said gas diffusion zone.

One of the advantageous of the present invention has been the discovery that the resulting polymeric product also possesses less odor, particularly after compounding into finished products by one or more further processing steps, for example in the manufacture of molded hoses and other products by vulcanization. Especially low odor products are obtained by the use of metal complexes in the +2 formal oxidation state, such as those containing a piperylene ligand group, especially (t-butylamido)dimethyl(tetramethylcyclopentadienyl)titanium (II) 1,3-pentadiene.

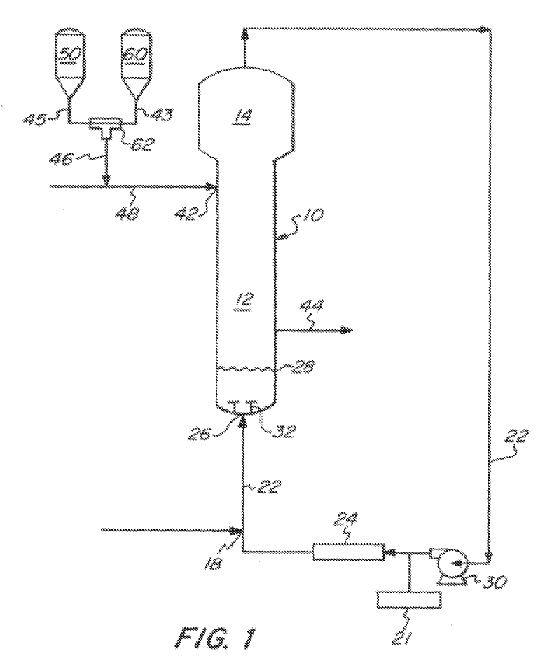

FIG. 1 is a schematic illustration of a process according to the present invention utilizing a fluidized bed, gas phase polymerization reactor.

All references herein to elements or metals belonging to a certain Group refer to the Periodic Table of the Elements published and copyrighted by CRC Press, Inc., 1999. Also any reference to the Group or Groups shall be to the Group or Groups as reflected in this Periodic Table of the Elements using the IUPAC system for numbering groups. For purposes of United States patent practice, the contents of any patent, patent application or publication referenced herein are hereby incorporated by reference in their entirety herein, especially with respect to the disclosure of organometallic structures, synthetic techniques and general knowledge in the art. As used herein the term “aromatic” or “aryl” refers to a polyatomic, cyclic, ring system containing (4δ+2)π-electrons, wherein δ is an integer greater than or equal to 1.

Mooney viscosity (Mooney) as used herein refers to polymer viscosity as determined by ASTM D1646 for ML 1+4 at 125° C.±0.5° C. It is a unit-less measure of elastomeric polymer viscosity well known in the industry. For polymers containing carbon black in significant concentration, especially concentrations in excess of 10 weight percent, a correction factor to adjust for the influence of such carbon black component is applied to experimentally derived Mooney viscosity values. The correction factor is determined empirically by measurement of Mooney viscosity values of compounded products of the same or similar polymer composition with and without equivalent levels of carbon black added thereto.

By reference to the foregoing preferred embodiments, the skilled artisan is readily apprised of the fact that the present invention in preferred embodiments involves the polymerization of one or more conjugated or non-conjugated diene monomers having from 4 to 20 carbon atoms, ethylene, and optionally one or more C₃₋₈ α-olefins, and/or that it may utilize a flow aid, which preferably is a solid, most preferably a solid comprising elemental carbon, highly preferably, carbon black. Moreover, the invention preferably utilizes one or more of the metal complexes disclosed in more detail hereinafter. Additionally, the invention preferably employs temperatures in the reaction zone of the gas phase reactor of at least 50° C., preferably at least 60° C., more preferably from 65 to 90° C., with an upward velocity of gases in said reaction zone sufficient to maintain the reactor contents in a suspended and gas fluidized condition. Still further, the invention preferably results in preparation of polymers having a Mooney viscosity of at least 100, more preferably at least 150, most preferably at least 200. Finally, the invention includes any combination or subcombination of the foregoing specifically identified conditions or results.

The present gas phase polymerization reactions may be carried out in fluidized bed reactors and stirred or paddle-type reactors. While the following discussion will feature fluidized bed reactors, where the present invention has been found to be preferred and especially advantageous, it is to be understood that the general concepts relating to the use of the transition metal olefin polymerization catalysts in liquid form, which are discussed relevant to the preferred fluidized bed reactors, are also applicable to the stirred or paddle-type reactors as well. The present invention is not limited to any specific type of gas phase reactor.

In very general terms, the fluidized bed process for producing resins is conducted by passing a gaseous stream containing the foregoing monomers continuously through a fluidized bed reactor under reactive conditions and in the presence of catalyst at a velocity sufficient to maintain the bed of solid particles in a suspended condition. The gaseous stream containing unreacted gaseous monomer is withdrawn from the reactor continuously, compressed, cooled and recycled into the reactor. Product is withdrawn from the reactor and make-up monomer is added to the recycle stream.

A basic, fluidized bed system for use herein is illustrated in FIG. 1. The reactor 10 comprises a reaction zone 12 and a velocity reduction zone 14. While a reactor configuration comprising a generally cylindrical region encompassing the fluidized bed beneath an expanded section is shown in FIG. 1, alternative configurations such as a reactor configuration comprising an entirely or partially tapered reactor may also be utilized. In such configurations, the fluidized bed is located within a tapered reaction zone but below a region of greater cross-sectional area which serves as the velocity reduction zone of the more conventional reactor configuration shown in FIG. 1.

In general, the height to diameter ratio of the reaction zone can vary in the range of 2.7:1 to 5:1. The range may vary to larger or smaller ratios and depends upon the desired production capacity. The cross-sectional area of the velocity reduction zone 14 is typically within the range of from 2.5 to 2.9 multiplied by the cross-sectional area of the reaction zone 12.

The reaction zone 12 includes a bed of growing polymer particles, formed polymer particles and a minor amount of catalyst, all fluidized by the continuous flow of various components, including monomers, inert compounds, and optional or required flow aids, in the form of make-up feed and recycle fluid through the reaction zone. To maintain a viable fluidized bed, the superficial gas velocity through the bed must exceed the minimum flow required for fluidization which is typically from 0.2 to 0.5 ft/sec (0.06 to 0.15 m/s). Preferably, the superficial gas velocity is at least 0.2 ft/sec (0.06 m/s) above the minimum flow for fluidization or from 0.4 to 0.7 ft/sec (0.12 to 0.21 m/s). Ordinarily, the superficial gas velocity will not exceed 5.0 ft/sec (1.5 m/s) and is usually no more than 2.5 ft/sec (0.76 m/s).

On start-up, the reactor is generally charged with a bed of particulate polymer particles before gas flow is initiated. Such particles help to prevent the formation of localized “hot spots” when catalyst feed is initiated. They may be the same as the polymer to be formed or different. When different, they are withdrawn with the desired newly formed polymer particles as the first product. Eventually, a fluidized bed comprising desired polymer particles supplants the start-up bed.

Fluidization is achieved by a high rate of fluid recycle to and through the bed, typically on the order of 50 times the rate of feed or make-up fluid. This high rate of recycle provides the requisite superficial gas velocity necessary to maintain the fluidized bed. The fluidized bed has the general appearance of a dense mass of individually moving particles as created by the percolation of gas through the bed. The pressure drop through the bed is equal to or slightly greater than the weight of the bed divided by the cross-sectional area. Make-up fluids are fed at point 18 via recycle line 22. The composition of the recycle stream is typically measured by a gas analyzer 21 and the composition and amount of the make-up stream is then adjusted accordingly to maintain an essentially steady state gaseous composition within the reaction zone. The gas analyzer 21 can be positioned to receive gas from a point between the velocity reduction zone 14 and heat exchanger 24, preferably, between compressor 30 and heat exchanger 24.

To ensure complete fluidization, the recycle stream and, where desired, at least part of the make-up stream are returned through recycle line 22 to the reactor at point 26 below the bed. Preferably, there is a gas distributor plate 28 above the point of return to aid in fluidizing the bed uniformly and to support the solid particles prior to start-up or when the system is shut down. The stream passing upwardly through and out of the bed removes the heat of reaction generated by the exothermic polymerization reaction.

The portion of the gaseous stream flowing through the fluidized bed which does not react in the bed becomes the recycle stream which leaves the reaction zone 12 and passes into the velocity reduction zone 14 above the bed where a major portion of the entrained particles drop back onto the bed thereby reducing solid particle carryover. The recycle stream is then compressed in compressor 30 and passed through heat exchanger 24 where the heat of reaction is removed from the recycle stream before it is returned to the bed. The recycle stream exiting the heat exchange zone is then returned to the reactor at its base 26 and thence to the fluidized bed through gas distributor plate 28. A fluid flow deflector 32 is preferably installed at the inlet to the reactor to prevent entrained polymer particles from settling out and agglomerating into a solid mass and to maintain entrained or to re-entrain any particles or liquid droplets that settle out or become disentrained.

Particulate polymer product is discharged from line 44. Although not shown, it is desirable to separate any fluid from the product and to return the fluid to reactor vessel 10. In accordance with the present invention, the polymerization catalyst enters the reactor in liquid form at a point 42 through line 48. If the catalyst requires the use of one or more co-catalysts, as is usually the case, the one or more co-catalysts may be introduced separately into the reaction zone where they will react with the catalyst to form the catalytically active reaction product. It is desirable, however, to premix the catalyst and co-catalyst(s) prior to their introduction into the reaction zone. It is to be understood that all of the various embodiments for introducing the polymerization catalyst into the reaction zone are broadly applicable to the present invention.

In the embodiment illustrated in FIG. 1, the catalyst and co-catalyst are mixed prior to their introduction into the reaction zone. The group 4 metal catalyst in the form of a solution in a suitable solvent or diluent from tank 50 is fed through line 45 to a mixing tee 62 where it is mixed with one or more co-catalysts from tank 60 which is fed to mixing tee 62 through line 43. The catalyst and co-catalyst(s) are provided in liquid form, that is, in the absence of any support. Once the mixture is in line 46, the catalyst/co-catalysts mixture react with one another to form the desired catalytic reaction product in situ. Generally, the length of line 46 is such that it provides ample residence time for the catalyst/co-catalyst(s) to react with one another and form the desired reaction product which remains in solution. In this manner, once the catalyst reaches line 48 and enters the reactor at point 42, substantially all of the catalyst/co-catalyst(s) will have reacted and catalytically reactive reaction product, which will have formed in situ, will desirably be introduced into the reaction zone in liquid form.

The substances that are desirably utilized to form solutions of the group 4 metal compounds are liquids, preferably aliphatic, alicyclic or aromatic hydrocarbons including butane, isobutane, ethane, propane, pentane, isopentane, hexane, octane, decane, dodecane, hexadecane, octadecane, cyclopentane, methylcyclopentane, cyclohexane, cyclooctane, norbornane, ethylcyclohexane, benzene, toluene, ethylbenzene, propylbenzene, butylbenzene, and xylene. Mixtures of the foregoing compounds including petroleum fractions such as gasoline, kerosene, light oils, oligomeric addition products, and hydrogenated derivatives thereof, such as a mixture of hydrogenated propylene oligomers, mostly C₆-C₁₂ isoalkanes, available commercially under the trademark Isopar E™ from Exxon Chemicals Inc., may be used as well. A preferred liquid for the foregoing purpose is ethylbenzene.

The concentration of catalyst or co-catalyst that is provided in solution as it is being introduced into the reaction zone may be as high as the saturation point of the particular solvent being used. Preferably, the concentration is in the range of from 1.0 to 50,000 μmole/liter, more preferably from 1000 to 20000 μmole/l. As a result of experiments performed herein it has been discovered that certain of the group 4 metal complexes, especially the dihalide containing complexes, are more soluble in the foregoing aliphatic or aromatic solvents in the presence of the cocatalyst, especially an alumoxane such as methylalumoxane (MAO) or triisobutylaluminum modified methylalumoxane (MMAO). Thus according to one embodiment of the present invention the metal complex is added to a preformed solution of the cocatalyst in an aliphatic or aromatic liquid prior to addition to the reactor.

The size of the droplets formed when introducing the catalyst into the reactor is generally determined by the manner and place in which the catalyst is introduced. It is desirable to use a means of introduction which is able to provide liquid droplets within the reactor having an average diameter which is in the range of from 5 to 1000 μm, preferably within the range of from 50 to 500 μm, so as to desirably form polymer product having a particle size within the range of from 500 to 5,000 μm.

The catalyst in liquid form (with or without a co-catalyst) may be introduced into the reaction zone by simply passing the catalyst in liquid form, under pressure, through a conduit extending into the reactor, which may be assisted by an inert gas (such as nitrogen) and/or an inert liquid (such as isopentane, and propane) to aid in atomization so as to provide the desired liquid droplet size. The catalyst in liquid form may be introduced by conventional means such as, for example, using positive displacement pumps, and pressurizing the holding tank with an inert gas. The extent of pressurization, the diameter of the conduit, the type and size of atomization nozzle (if one is used), the velocity with which the catalyst is introduced into the reactor, the superficial gas velocity of the fluids within the reactor, as well as the pressure within the reaction zone will all influence the liquid droplet size that is formed. It is well within the knowledge of those skilled in this art to vary one or more of these parameters to the extent desired while adjusting still others to obtain a desired droplet size within the reaction zone.

Preferably, the catalyst in liquid form is introduced into the reactor by means of a conventional two fluid spray nozzle in which an inert gas is used to help atomize the catalyst. The use of such a spray nozzle allows for greater control of the liquid droplet size that is produced in the reaction zone by providing enhanced atomization capability. The selection of a particular spray nozzle/tip for use with the catalyst in liquid form to provide a desired average droplet size, must take into account the reaction conditions within the reactor as well as the flow rate of the catalyst. Generally, the orifice diameter in the spray nozzle/tip is in the range of from 0.01 to 0.15 inch (0.25 to 3.8 mm), preferably from 0.02 to 0.05 inch (0.50 to 1.3 mm).

The catalyst in liquid form can be introduced intermittently or continuously into the reactor at a desired rate at point 42, which is above distributor plate 28 (the “reaction zone”). Intermittent catalyst feeding may be used to help keep the catalyst solution flow rate in the proper range for optimum nozzle performance while independently maintaining the desired average catalyst feed rate. It is desirable to maintain a continuous flow of the inert carrier through the nozzle, be it a liquid or gas, at a rate sufficient to prevent fouling of the injection nozzle. Conventional metering valves or pumps can be used to deliver a precise flow of the catalyst to the reactor. Controlled intermittent catalyst flow may be delivered to the reactor using conventional syringe or positive displacement pumps.

Good gas distribution plays an important role in the operation of the reactor. The fluidized bed contains growing and formed particulate polymer particles that must be prevented from settling, for if a quiescent mass is allowed to exist, any active catalyst contained therein may continue to react and cause fusing of the particles. Diffusing recycle fluid through the bed at a rate sufficient to maintain fluidization throughout the bed is, therefore, important.

Gas distribution plate 28 is a preferred means for achieving good gas distribution and may be a screen, slotted plate, perforated plate, a plate of the bubble-cap type and the like. The elements of the plate may all be stationary, or the plate may be of the mobile type disclosed in U.S. Pat. No. 3,298,792. Whatever its design, it serves to diffuse the recycle fluid through the particles at the base of the bed to keep the bed in a fluidized condition, and also serves to support a quiescent bed of resin particles when the reactor is not in operation. The preferred type of gas distributor plate 28 is metal and has holes distributed across its surface. The holes are normally of a diameter of ½ inch (12.5 mm) and extend through the plate. Over each hole there may be positioned a diversion device (not depicted) to cause turbulent flow beyond the distribution plate so as to avoid stagnant zones of solids. In addition the diversion devices prevent the polymer from flowing back through the holes when gas flow is discontinued.

Injection of the catalyst in liquid form into the reactor is preferably carried out in the upper portion of the fluidized bed to provide uniform distribution and to minimize catalyst carryover into the recycle line where polymerization may begin and plugging of the recycle line and heat exchanger may eventually occur. Carryover of catalyst into the recycle line can result in polymerization occurring outside the reactor reaction zone which can cause plugging of the recycle line and fouling in the heat exchanger. However, if desired, the catalyst in liquid form may be introduced into the reactor entirely above the fluidized bed at a point in the reactor which is still low enough so as to minimize any catalyst carryover into the recycle line taking into account the cross-sectional area of the reactor at the point of catalyst injection, the velocity of the gaseous stream passing through the fluidized bed, the entry point into the reactor for the catalyst and the droplet size of the catalyst. An inert protecting blanket or “shroud” of gas or vaporizable liquid, optionally heated above the temperature of the catalyst liquid, may be employed to assist in dispersing the catalyst before contact with monomer or polymer particles can occur. The use of a “shroud” gas can help prevent localized over-heating in the reactor and the formation of agglomerations of polymer product and improve the flowability of the resulting product. Suitable temperatures for the shroud gas are from 20 to 120° C. A heated shroud gas generally is heated to a temperature at least 20° C. above the polymerization temperature of the reactor. Desirably, the quantity of liquid catalyst added to the reactor does not exceed the amount that can be readily absorbed onto polymer particles so that no dissolution of existing polymer particles and resulting loss of polymer morphology occurs.

The rate of polymer production in the bed depends on the rate of catalyst injection, the activity of the catalyst, and the concentration of monomer(s) in the recycle stream at the particular reaction conditions, and the temperature of the reaction zone. Generally, from 100,000 to 5,000,000 kilograms of polymer may produced for every kilogram of group 4 metal contained within the catalyst that is introduced into the reactor. The production rate is conveniently controlled by simply adjusting the rate of catalyst introduction.

Under a given set of operating conditions, the fluidized bed is maintained at essentially a constant height by withdrawing a portion of the bed as product at a rate essentially equivalent to the rate of formation of the particulate polymer product. The temperature of the catalyst in liquid form as it is introduced into the reactor is not critical. Typically, the temperature of the catalyst in liquid form may simply be at ambient temperature. The fluid bed reactor is typically operated at pressures of up to 1,000 psig (7 MPa), preferably from 250 to 500 psig (1.7-4.3 MPa), with operation at the higher pressures in such ranges being favorable since higher heat transfer is experienced due to an increase in the unit volume heat capacity of the gas as the pressure is increased.

To maximize heat removal it was not unusual to spray or inject liquid into or onto the polymer bed where it flashes into a gaseous state by exposure to the hotter recycle gas stream. A limited amount of additional cooling may be achieved by this technique by the Joules-Thompson effect, but without cooling the recycle gas stream to a level where condensation might occur. This approach typically involves cooling a portion of the cycle gas stream to a temperature less than that of the reaction zone in the reactor, preferably sufficiently cool to obtain liquid monomer for storage and subsequent separate introduction into or onto the polymerization bed. Examples of this procedure are found in U.S. Pat. Nos. 3,254,070; 3,300,457; 3,652,527 and 4,012,573.

The use of the foregoing condensed liquids as well as use of liquid monomers per se is possible according to the present invention, so long as the quantity of such condensed liquids or liquid monomers is limited to a quantity that may be readily adsorbed on or absorbed in solid particulate matter present in the bed, such as the polymer being produced or fluidization aids present in the bed, such that there is no substantial amount of free liquid monomer or condensed liquids present more than a short distance above the point of entry into the polymerization zone.

The term “sticky polymer” as used herein is defined as a polymer, which, while in particulate form, agglomerates at temperatures above a certain temperature (referred to as the “sticking temperature” or “softening temperature”. The term “sticking temperature”, which, in the context of this specification, concerns the sticking temperature of particles of polymer in a fluidized bed, is defined as the temperature at which fluidization ceases due to excessive agglomeration of particles in the bed. The agglomeration may be spontaneous or occur during short periods of operation under less than fully fluidized operating conditions, in which the polymer bed experiences settling.

A polymer may be inherently sticky due to its chemical or mechanical properties or pass through a sticky phase during the production cycle. Sticky polymers are also referred to as non-free flowing polymers because of their tendency to compact into agglomerates of much larger size than the original particles. Polymers of this type show acceptable fluidity during normal operation of a gas phase fluidized bed reactor; however, once motion ceases, agglomerates form which prevent acceptable operation of the fluidized bed.

These polymers are further classified as those, which have a minimum bin opening for free flow at zero storage time of two feet (0.6 m) and a minimum bin opening for free flow at storage times of greater than five minutes of 4 to 8 feet (1.2 to 2.4 m) or more. Sticky polymers can also be defined by their bulk flow properties. This is called the Flow Function. On a scale of zero to infinity, the Flow Function of free flowing materials such as dry sand is infinite. The Flow Function of free flowing polymers is generally from 4 to 10, while the Flow Function of non-free flowing or sticky polymers is less than 4, usually from 1 to 3.

Although many variables influence the degree of stickiness of the polymer resin, it is predominantly governed by the temperature and the crystallinity of the resin. Higher temperatures of the resin increase its stickiness while less crystalline products such as the present essentially amorphous or elastomeric polymers usually display a larger tendency to agglomerate into larger particles.

Under the present gas phase polymerization conditions, stickiness of the polymer particles or granules is avoided by use of a flow aid, especially a fine-particle size, solid, inorganic material which is capable of substantially preventing such agglomeration. Examples of suitable flow aids for use herein include: silanes and other silicon compounds, carbon black, clay, and treated derivatives thereof, especially, carbon black or clay having a surface coating of a polysiloxane, such as a polydihydrocarbylsiloxane, having from 1 to 20 carbons in each hydrocarbyl group.

Suitably the flow aid is employed in an amount from 1 to 80 weight percent based on the weight of the final product. A preferred flow aid is carbon black containing polydimethylsiloxane in an amount 0.1 to 20 percent based on the weight of carbon.

Unless specifically stated to the contrary the polymers herein desirably have Mooney viscosities from 10 to 250, preferably from 40 to 230. As previously stated, the instant process is notable in that much higher Mooney viscosity diene polymers may be prepared than previously possible in a gas phase process. Preferred processes herein are those incorporating any combination of preferred operating conditions such as reactor zone temperature greater than 50° C., preferably greater than 60° C., more preferably from 65 to 90° C.; Mooney viscosities of the resulting polymer greater than 100, preferably greater than 150, most preferably greater than 200, in a process operating continuously and at high efficiency.

Suitable diene monomers for use herein include 1,3-butadiene, 1,3-pentadiene, dicyclopentadiene, alkyldicyclopentadiene, 1,4-pentadiene, 1,4-hexadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, and 5-(2-methyl-2-butenyl)-2-norbornene. Suitable diene monomers utilized in forming the EPDM terpolymers include dicyclopentadiene, alkyldicyclopentadiene, 1,4-pentadiene, 1,4-hexadiene, 1,5-hexadiene, 1,4-heptadiene, 2-methyl-1,5-hexadiene, cyclooctadiene, 1,4-octadiene, 1,7-octadiene, 5-ethylidene-2-norbornene, 5-n-propylidene-2-norbornene, and 5-(2-methyl-2-butenyl)-2-norbornene.

Suitable addition polymerizable monomers for use herein are those monomers having from 2 to 20,000, preferably from 3 to 20, more preferably from 3 to 8 carbon atoms, preferably olefins, including combinations of two or more olefins. Particularly suitable olefins include ethylene; α-olefins, for example, propylene, 1-butene, 1-pentene, 4-methylpentene-1,1-hexene, 1-heptene, 1-octene, 1-nonene, 1-decene, 1-undecene, 1-dodecene, 1-tridecene, 1-tetradecene, 1-pentadecene, or combinations thereof; vinylaromatic monomers, especially styrene, α-methylstyrene and ring alkyl-substituted styrenes, such as p-methylstyrene; as well as long chain vinyl terminated oligomeric or polymeric reaction products formed during the polymerization; and C₁₀₋₃₀ α-olefins specifically added to the reaction mixture in order to produce relatively long chain branches in the resulting polymers. Preferably, the alpha-olefin is propylene. Other monomers including halo-substituted styrenes, tetrafluoroethylene, and vinylcyclobutene may also be employed if desired.

Preferred polymers prepared according to the present invention comprise in polymerized form, ethylene, propylene, and a non-conjugated diene. Such polymers are referred to as ethylene/propylene/diene monomer terpolymers or EPDM terpolymers. Preferred EPDM polymers are those having from 0.1, more preferably from 1.5 up to 10, more preferably up to 5 weight percent diene, and from 10, more preferably 20 up to 50, more preferably 35 weight percent propylene, with the balance of the terpolymer being ethylene. Preferably, the EPDM does not have more than 4 weight percent, and more preferably, not more than 2 weight percent residual unsaturation.

Suitable metal complexes (also referred to as catalysts) for use herein include any compound of Group 4 of the Periodic Table of the Elements containing the foregoing ligand group that is capable of being activated to cause polymerization under the present polymerization conditions. Preferably such complexes contain at least one ligand group bonded to the metal through delocalization of π-electrons thereof. Preferred compounds include metal complexes containing from 1 to 3 π-bonded anionic or neutral ligand groups, which may be cyclic or non-cyclic delocalized π-bonded anionic ligand groups. Exemplary of such π-bonded anionic ligand groups are conjugated or nonconjugated, cyclic or non-cyclic dienyl groups, allyl groups, boratabenzene groups, and arene groups. By the term “π-bonded” is meant that the ligand group is bonded to the transition metal by means of electrons participating in the delocalized π-bond of the ligand.

Each atom in the delocalized π-bonded group may independently be substituted with a radical selected from the group consisting of hydrogen, halogen, hydrocarbyl, halohydrocarbyl, hydrocarbyl-substituted metalloid radicals wherein the metalloid is selected from Group 14 of the Periodic Table of the Elements, and such hydrocarbyl- or hydrocarbyl-substituted metalloid radicals further substituted with a Group 15 or 16 hetero atom containing moiety. Included within the term “hydrocarbyl” are C₁₋₂₀ straight, branched and cyclic alkyl radicals, C₆₋₂₀ aromatic radicals, C₇₋₂₀ alkyl-substituted aromatic radicals, and C₇₋₂₀ aryl-substituted alkyl radicals. In addition two or more such radicals may together form a fully or partially saturated fused ring system, an unsaturated fused ring system, or a metallocycle with the metal. Suitable hydrocarbyl-substituted organometalloid radicals include mono-, di- and tri-substituted organometalloid radicals of Group 14 elements wherein each of the hydrocarbyl groups contains from 1 to 20 carbon atoms. Examples of suitable hydrocarbyl-substituted organometalloid radicals include trimethylsilyl, triethylsilyl, ethyldimethylsilyl, methyldiethylsilyl, triphenylgermyl, and trimethylgermyl groups. Examples of Group 15 or 16 hetero atom containing moieties include amine, phosphine, ether or thioether moieties or divalent derivatives thereof, for example amide, phosphide, ether or thioether groups bonded to the transition metal or Lanthamide metal, and bonded to the hydrocarbyl group or to the hydrocarbyl-substituted metalloid containing group.

Examples of suitable anionic, delocalized π-bonded groups include cyclopentadienyl, indenyl, fluorenyl, tetrahydroindenyl, tetrahydrofluorenyl, octahydrofluorenyl, pentadienyl, cyclohexadienyl, dihydroanthracenyl, hexahydroanthracenyl, decahydroanthracenyl groups, and boratabenzene groups, as well as C₁₋₁₀ hydrocarbyl-substituted or C₁₋₁₀ hydrocarbyl-substituted silyl substituted derivatives thereof. Preferred anionic delocalized π-bonded groups are cyclopentadienyl, pentamethylcyclopentadienyl, tetramethylcyclopentadienyl, tetramethylsilylcyclopentadienyl, indenyl, 2,3-dimethylindenyl, fluorenyl, 2-methylindenyl, 2-methyl-4-phenylindenyl, tetrahydrofluorenyl, octahydrofluorenyl, and tetrahydroindenyl.

The boratabenzenes are anionic ligands which are boron containing six membered ring systems. They are previously known in the art having been described by G. Herberich, et al., in Organometallics, 14, 1, 471-480 (1995). They may be prepared by reaction of tin hexadiene compounds and a borontrihalide followed by substitution with a hydrocarbyl, silyl or germyl group. Such groups correspond to the formula: 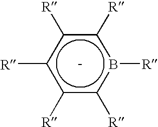
wherein R″ is selected from the group consisting of hydrocarbyl, silyl, or germyl, said R″ having up to 50, preferably up to 20 non-hydrogen atoms. In complexes involving divalent derivatives of such groups, R″ is a covalent bond or a divalent derivative of one of the foregoing groups, which is also bonded to another atom of the complex thereby forming a bridged system.

A suitable class of catalysts are transition metal complexes correspond to the formula:
L₁MXₘX′ₙX″ₚ, or a dimer thereof

wherein:

L is an anionic, delocalized, π-bonded group that is bound to M, containing up to 50 non-hydrogen atoms, optionally two L groups may be joined together forming a bridged structure, and further optionally one L may be bound to X, or even further optionally one L may be bound to X′;

M is a metal of Group 4 of the Periodic Table of the Elements in the +2, +3 or +4 formal oxidation state;

X is an optional, divalent substituent of up to 50 non-hydrogen atoms that together with L forms a metallocycle with M;

X′ is an optional neutral ligand having up to 20 non-hydrogen atoms;

X″ each occurrence is a monovalent, anionic moiety having up to 40 non-hydrogen atoms, optionally, two X″ groups may be covalently bound together forming a divalent dianionic moiety having both valences bound to M, or, optionally 2 X″ groups may be covalently bound together to form a neutral, conjugated or nonconjugated diene that is π-bonded to M (whereupon M is in the +2 oxidation state), or further optionally one or more X″ and one or more X′ groups may be bonded together thereby forming a moiety that is both covalently bound to M and coordinated thereto by means of Lewis base functionality;

l is 0, 1 or 2;

m is 0 or 1;

n is a number from 0 to 3;

p is an integer from 0 to 3; and

the sum, l+m+p, is equal to the formal oxidation state of M, except when 2 X″ groups together form a neutral conjugated or non-conjugated diene that is π-bonded to M, in which case the sum l+m is equal to the formal oxidation state of M.

Preferred complexes include those containing either one or two L groups. The latter complexes include those containing a bridging group linking the two L groups. Preferred bridging groups are those corresponding to the formula (ER*₂)ₓ wherein E is silicon, germanium, tin, or carbon, R* independently each occurrence is hydrogen or a group selected from silyl, hydrocarbyl, hydrocarbyloxy and combinations thereof, said R* having up to 30 carbon or silicon atoms, and x is 1 to 8. Preferably, R* independently each occurrence is methyl, ethyl, propyl, benzyl, tert-butyl, phenyl, methoxy, ethoxy or phenoxy. Preferably, x is 1 or 2.

Examples of the complexes containing two L groups are compounds corresponding to the formula:

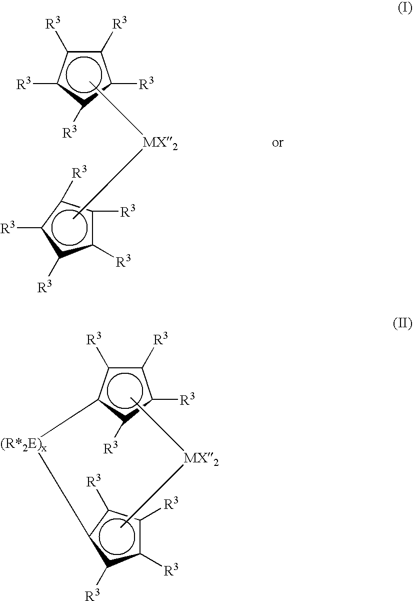

wherein:

M is titanium, zirconium or hafnium, preferably zirconium or hafnium, in the +2 or +4 formal oxidation state;

R³ in each occurrence independently is selected from the group consisting of hydrogen, hydrocarbyl, hydrocarbyloxy, silyl, germyl, cyano, halo and combinations thereof, (especially, hydrocarbyloxysilyl, halocarbyl, and halohydrocarbyl) said R³ having up to 20 non-hydrogen atoms, or adjacent R³ groups together form a divalent derivative (that is, a hydrocarbadiyl, siladiyl or germadiyl group) thereby forming a fused ring system, and

X″ independently each occurrence is an anionic ligand group of up to 40 non-hydrogen atoms, or two X″ groups together form a divalent anionic ligand group of up to 40 non-hydrogen atoms or together are a conjugated diene having from 4 to 30 non-hydrogen atoms forming a π-complex with M, whereupon M is in the +2 formal oxidation state, and

R*, E and x are as previously defined.

Exemplary bridged ligands containing two π-bonded groups are: (dimethylsilyl-bis(cyclopentadienyl)), (dimethylsilyl-bis(methylcyclopentadienyl)), (dimethylsilyl-bis(ethylcyclopentadienyl)), (dimethylsilyl-bis(t-butylcyclopentadienyl)), (dimethylsilyl-bis(tetramethylcyclopentadienyl)), (dimethylsilyl-bis(indenyl)), (dimethylsilyl-bis(tetrahydroindenyl)), (dimethylsilyl-bis(fluorenyl)), (dimethylsilyl-bis(tetrahydrofluorenyl)), (dimethylsilyl-bis(2-methyl-4-phenylindenyl)), (dimethylsilyl-bis(2-methylindenyl)), (dimethylsilyl-cyclopentadienyl-fluorenyl), (dimethylsilyl-cyclopentadienyl-octahydrofluorenyl), (dimethylsilyl-cyclopentadienyl-tetrahydrofluorenyl), (1,1,2,2-tetramethyl-1,2-disilyl-bis-cyclopentadienyl), (1,2-bis(cyclopentadienyl)ethane, and (isopropylidene-cyclopentadienyl-fluorenyl).

Preferred X″ groups are selected from hydride, hydrocarbyl, silyl, germyl, halohydrocarbyl, halosilyl, silylhydrocarbyl and aminohydrocarbyl groups, or two X″ groups together form a divalent derivative of a conjugated diene or else together they form a neutral, π-bonded, conjugated diene. Most preferred X″ groups are C₁₋₂₀ hydrocarbyl groups. Examples of the foregoing group 4 metal complexes are zirconium and hafnium complexes, especially hafnium complexes, such as bis(2-t-butylcyclopentadien-1-yl)hafnium dimethyl, dimethylsilyl(bisindenyl hafnium dimethyl), dimethylsilyl(bis-2-methyl-4-phenylinden-1-yl)hafnium dimethyl. Additional suitable metal complexes are those disclosed in WO 97/22635.

A further class of metal complexes utilized in the present invention corresponds to the preceding formula L₁MXₘX′ₙX″ₚ, or a dimer thereof, wherein X is a divalent substituent of up to 50 non-hydrogen atoms that together with L forms a metallocycle with M, or wherein one X′ is bound to both L and M.

Preferred divalent X substituents include groups containing up to 30 non-hydrogen atoms comprising at least one atom that is oxygen, sulfur, boron or a member of Group 14 of the Periodic Table of the Elements directly attached to the delocalized π-bonded group, and a different atom, selected from the group consisting of nitrogen, phosphorus, oxygen or sulfur that is covalently bonded to M.

A preferred class of such Group 4 metal coordination complexes used according to the present invention corresponds to the formula:

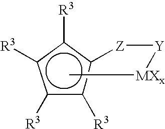

wherein:

M is titanium or zirconium in the +2, +3 or +4 formal oxidation state;

R³ in each occurrence independently is selected from the group consisting of hydrogen, hydrocarbyl, silyl, germyl, cyano, halo and combinations thereof, said R³ having up to 20 non-hydrogen atoms, or adjacent R³ groups together form a divalent derivative (such as a hydrocarbadiyl, siladiyl or germadiyl group) thereby forming a fused ring system,

each X is a hydride group or a hydrocarbyl, hydrocarbyloxy, or trihydrocarbylsilyl group, or a dihydrocarbylamino-, hydrocarbyleneamino-, hydrocarbyloxy-, or trihydrocarbylsilyl-substituted derivative thereof, said group or substituted group having up to 30 non-hydrogen atoms, or two X groups together form a neutral C₄₋₆₀ conjugated diene or a divalent derivative thereof;

x is 1, 2 or 3 selected to provide charge balance;

Y is —O—, —S—, —NR*—, —PR*—; and

Z is SiR*₂, CR*₂, SiR*₂SiR*₂, CR*₂CR*₂, CR*═CR*, CR*₂SiR*₂, SnR*₂, or GeR*₂, wherein R* is hydrogen, or C₁₋₁₀ hydrocarbyl.

Highly preferred Group 4 metal complexes that may be employed in the practice of the present invention are those capable of high conversion of the diene monomer and incorporation thereof in a random or non-blocky manner into a copolymer if one is formed. In addition, metal complexes resulting in low ethylene homopolymer formation are also desired. Generally the foregoing results are obtainable by the use of a metal complex that achieves high comonomer incorporation into an ethylene copolymer.

Highly preferred group 4 metal complexes for use herein correspond to the formula:

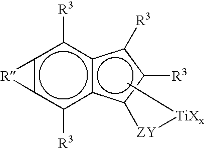

Wherein R³, Z, Y, X and x are as previously defined, and

R″ is a divalent hydrocarbylene- or substituted hydrocarbylene group forming a fused system with the remainder of the metal complex, said R″ containing from 1 to 30 nonhydrogen atoms.

Most highly preferred metal complexes are substituted s-indacenyl titanium or gem-dimethylacenaphthalenyl titanium complexes corresponding to the formula:

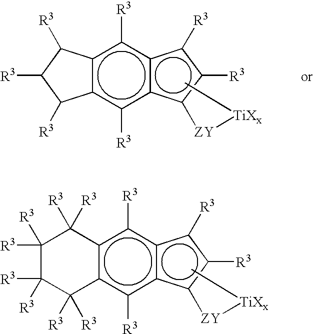

wherein R³, X, Y, Z and x are as previously defined.

Illustrative metal complexes that may be employed in the practice of the present invention include:
(t-butylamido)dimethyl(η⁵-tetramethylcyclopentadienyl)silanetitanium (II) 1,4-diphenyl-1,3-butadiene,
(t-butylamido)dimethyl(η⁵-tetramethylcyclopentadienyl)silanetitanium (II) 1,3-pentadiene,
(t-butylamido)dimethyl(η⁵-tetramethylcyclopentadienyl)silanetitanium (III) 2-(N,N-dimethylamino)benzyl,
(t-butylamido)dimethyl(η⁵-tetramethylcyclopentadienyl)silanetitanium (IV) dimethyl,
(t-butylamido)dimethyl(η⁵-tetramethylcyclopentadienyl)silanetitanium (IV) dichloride,
(t-butylamido)dimethyl(η⁵-tetramethylcyclopentadienyl)silanetitanium (IV) bis(trimethylsilyl),
(cyclohexylamido)dimethyl(η⁵-tetramethylcyclopentadienyl)silanetitanium (II) 1,4-diphenyl-1,3-butadiene,
(cyclohexylamido)dimethyl(η⁵-tetramethylcyclopentadienyl)silanetitanium (II) 1,3-pentadiene,
(cyclohexylamido)dimethyl(η⁵-tetramethylcyclopentadienyl)silanetitanium (III) 2-(N,N-dimethylamino)benzyl,
(cyclohexylamido)dimethyl(η⁵-tetramethylcyclopentadienyl)silanetitanium (IV) dimethyl,
(cyclohexylamido)dimethyl(η⁵-tetramethylcyclopentadienyl)silanetitanium (IV) dichloride,
(cyclohexylamido)dimethyl(η⁵-tetramethylcyclopentadienyl)silanetitanium (IV) bis(trimethylsilyl),
(cyclododecylamido)dimethyl(η⁵-tetramethylcyclopentadienyl)silanetitanium (II) 1,4-diphenyl-1,3-butadiene,
(cyclododecylamido)dimethyl(η⁵-tetramethylcyclopentadienyl)silanetitanium (II) 1,3-pentadiene,
(cyclododecylamido)dimethyl(η⁵-tetramethylcyclopentadienyl)silanetitanium (II) 2-(N,N-dimethylamino)benzyl,
(cyclododecylamido)dimethyl(η⁵-tetramethylcyclopentadienyl)silanetitanium (IV) dimethyl,
(cyclododecylamido)dimethyl(η⁵-tetramethylcyclopentadienyl)silanetitanium (IV) dichloride,
(cyclododecylamido)dimethyl(η⁵-tetramethylcyclopentadienyl)silanetitanium (IV) bis(trimethylsilyl),
(t-butylamido)dimethyl(η⁵-inden-1-yl)silanetitanium (II) 1,4-diphenyl-1,3-butadiene,
(t-butylamido)dimethyl(η⁵-inden-1-yl)silanetitanium (II) 1,3-pentadiene,
(t-butylamido)dimethyl(η⁵-inden-1-yl)silanetitanium (III) 2-(N,N-dimethylamino)benzyl,
(t-butylamido)dimethyl(η⁵-inden-1-yl)silanetitanium (IV) dimethyl,
(t-butylamido)dimethyl(η⁵-inden-1-yl)silanetitanium (IV) dichloride,
(t-butylamido)dimethyl(η⁵-inden-1-yl)silanetitanium (IV) bis(trimethylsilyl),
(cyclohexylamido)dimethyl(η⁵-inden-1-yl)silanetitanium (II) 1,4-diphenyl-1,3-butadiene,
(cyclohexylamido)dimethyl(η⁵-inden-1-yl)silanetitanium (II) 1,3-pentadiene,
(cyclohexylamido)dimethyl(η⁵-inden-1-yl)silanetitanium (III) 2-(N,N-dimethylamino)benzyl,
(cyclohexylamido)dimethyl(η⁵-inden-1-yl)silanetitanium (IV) dimethyl,
(cyclohexylamido)dimethyl(η⁵-inden-1-yl)silanetitanium (IV) dichloride,
(cyclohexylamido)dimethyl(η⁵-inden-1-yl)silanetitanium (IV) bis(trimethylsilyl),
(cyclododecylamido)dimethyl(η⁵-inden-1-yl)silanetitanium (II) 1,4-diphenyl-1,3-butadiene,
(cyclododecylamido)dimethyl(η⁵-inden-1-yl)silanetitanium (II) 1,3-pentadiene,
(cyclododecylamido)dimethyl(η⁵-inden-1-yl)silanetitanium (III) 2-(N,N-dimethylamino)benzyl,
(cyclododecylamido)dimethyl(η⁵-inden-1-yl)silanetitanium (IV) dimethyl,
(cyclododecylamido)dimethyl(η⁵-inden-1-yl)silanetitanium (IV) dichloride,
(cyclododecylamido)dimethyl(η⁵-inden-1-yl)silanetitanium (IV) bis(trimethylsilyl),
(t-butylamido)dimethyl(η⁵-2-methyl-4-phenylinden-1-yl)silanetitanium (II) 1,4-diphenyl-1,3-butadiene,
(t-butylamido)dimethyl(η⁵-2-methyl-4-phenylinden-1-yl)silanetitanium (II) 1,3-pentadiene,
(t-butylamido)dimethyl(η⁵-2-methyl-4-phenylinden-1-yl)silanetitanium (III) 2-(N,N-dimethylamino)benzyl,
(t-butylamido)dimethyl(η⁵-2-methyl-4-phenylinden-1-yl)silanetitanium (IV) dimethyl,
(t-butylamido)dimethyl(η⁵-2-methyl-4-phenylinden-1-yl)silanetitanium (IV) dichloride,
(t-butylamido)dimethyl(η⁵-2-methyl-4-phenylinden-1-yl)silanetitanium (IV) bis(trimethylsilyl),
(cyclohexylamido)dimethyl(η⁵-2-methyl-4-phenylinden-1-yl) silanetitanium (II) 1,4-diphenyl-1,3-butadiene,
(cyclohexylamido)dimethyl(η⁵-2-methyl-4-phenylinden-1-yl)silanetitanium (II) 1,3-pentadiene,
(cyclohexylamido)dimethyl(η⁵-2-methyl-4-phenylinden-1-yl)silanetitanium (III) 2-(N,N-dimethylamino)benzyl,
(cyclohexylamido)dimethyl(η⁵-2-methyl-4-phenylinden-1-yl)silanetitanium (IV) dimethyl,
(cyclohexylamido)dimethyl(η⁵-2-methyl-4-phenylinden-1-yl) silanetitanium (IV) dichloride,
(cyclohexylamido)dimethyl(η⁵-2-methyl-4-phenylinden-1-yl)silanetitanium (IV) bis(trimethylsilyl),
(cyclododecylamido)dimethyl(η⁵-2-methyl-4-phenylinden-1-yl)silanetitanium (II) 1,4-diphenyl-1,3-butadiene,
(cyclododecylamido)dimethyl(η⁵-2-methyl-4-phenylinden-1-yl)silanetitanium (II) 1,3-pentadiene,
(cyclododecylamido)dimethyl(η⁵-2-methyl-4-phenylinden-1-yl)silanetitanium (III) 2-(N,N-dimethylamino)benzyl,
(cyclododecylamido)dimethyl(η⁵-2-methyl-4-phenylinden-1-yl)silanetitanium (IV) dimethyl,
(cyclododecylamido)dimethyl(η⁵-2-methyl-4-phenylinden-1-yl)silanetitanium (IV) dichloride,
(cyclododecylamido)dimethyl(η⁵-2-methyl-4-phenylinden-1-yl)silanetitanium (IV) bis(trimethylsilyl),
(t-butylamido)dimethyl(η⁵-s-indacen-1-yl)silanetitanium (II) 1,4-diphenyl-1,3-butadiene,
(t-butylamido)dimethyl(η⁵-s-indacen-1-yl)silanetitanium (II) 1,3-pentadiene,
(t-butylamido)dimethyl(η⁵-s-indacen-1-yl)silanetitanium (III) 2-(N,N-dimethylamino)benzyl,
(t-butylamido)dimethyl(η⁵-s-indacen-1-yl)silanetitanium (IV) dimethyl,
(t-butylamido)dimethyl(η⁵-s-indacen-1-yl)silanetitanium (IV) dichloride,
(t-butylamido)dimethyl(η⁵-s-indacen-1-yl)silanetitanium (IV) bis(trimethylsilyl),
(cyclohexylamido)dimethyl(η⁵-s-indacen-1-yl)silanetitanium (II) 1,4-diphenyl-1,3-butadiene,
(cyclohexylamido)dimethyl(η⁵-s-indacen-1-yl)silanetitanium (II) 1,3-pentadiene,
(cyclohexylamido)dimethyl(η⁵-s-indacen-1-yl)silanetitanium (III) 2-(N,N-dimethylamino)benzyl,
(cyclohexylamido)dimethyl(η⁵-s-indacen-1-yl)silanetitanium (I) dimethyl,
(cyclohexylamido)dimethyl(η⁵-s-indacen-1-yl)silanetitanium (IV) dichloride,
(cyclohexylamido)dimethyl(η⁵-s-indacen-1-yl)silanetitanium (IV) bis(trimethylsilyl),
(cyclododecylamido)dimethyl(η⁵-s-indacen-1-yl)silanetitanium (II) 1,4-diphenyl-1,3-butadiene,
(cyclododecylamido)dimethyl(η⁵-s-indacen-1-yl)silanetitanium (II) 1,3-pentadiene,
(cyclododecylamido)dimethyl(η⁵-s-indacen-1-yl)silanetitanium (III) 2-(N,N-dimethylamino)benzyl,
(cyclododecylamido)dimethyl(η⁵-s-indacen-1-yl)silanetitanium (IV) dimethyl,
(cyclododecylamido)dimethyl(η⁵-s-indacen-1-yl)silanetitanium (IV) dichloride,
(cyclododecylamido)dimethyl(η⁵-s-indacen-1-yl)silanetitanium (IV) bis(trimethylsilyl),
(t-butylamido)dimethyl(η⁵-3-phenyl-s-indacen-1-yl)silanetitanium (II) 1,4-diphenyl-1,3-butadiene,
(t-butylamido)dimethyl(η⁵-3-phenyl-s-indacen-1-yl)silanetitanium (II) 1,3-pentadiene,
(t-butylamido)dimethyl(η⁵-3-phenyl-s-indacen-1-yl)silanetitanium (III) 2-(N,N-dimethylamino)benzyl,
(t-butylamido)dimethyl(η⁵-3-phenyl-s-indacen-1-yl)silanetitanium (IV) dimethyl,
(t-butylamido)dimethyl(η⁵-3-phenyl-s-indacen-1-yl)silanetitanium (IV) dichloride,
(t-butylamido)dimethyl(η⁵-3-phenyl-s-indacen-1-yl)silanetitanium (IV) bis(trimethylsilyl),
(cyclohexylamido)dimethyl(η⁵-3-phenyl-s-indacen-1-yl) silanetitanium (II) 1,4-diphenyl-1,3-butadiene,
(cyclohexylamido)dimethyl(η⁵-3-phenyl-s-indacen-1-yl)silanetitanium (II) 1,3-pentadiene,
(cyclohexylamido)dimethyl(η⁵-3-phenyl-s-indacen-1-yl) silanetitanium (III) 2-(N,N-dimethylamino)benzyl,
(cyclohexylamido)dimethyl(η⁵-3-phenyl-s-indacen-1-yl)silanetitanium (IV) dimethyl,
(cyclohexylamido)dimethyl(η⁵-3-phenyl-s-indacen-1-yl) silanetitanium (IV) dichloride,
(cyclohexylamido)dimethyl(η⁵-3-phenyl-s-indacen-1-yl)silanetitanium (IV) bis(trimethylsilyl),
(cyclododecylamido)dimethyl(η⁵-3-phenyl-s-indacen-1-yl)silanetitanium (II) 1,4-diphenyl-1,3-butadiene,
(cyclododecylamido)dimethyl(η⁵-3-phenyl-s-indacen-1-yl)silanetitanium (I) 1,3-pentadiene,
(cyclododecylamido)dimethyl(η⁵-3-phenyl-s-indacen-1-yl)silanetitanium (III) 2-(N,N-dimethylamino)benzyl,
(cyclododecylamido)dimethyl(η⁵-3-phenyl-s-indacen-1-yl)silanetitanium (IV) dimethyl,
(cyclododecylamido)dimethyl(η⁵-3-phenyl-s-indacen-1-yl)silanetitanium (IV) dichloride,
(cyclododecylamido)dimethyl(η⁵-3-phenyl-s-indacen-1-yl)silanetitanium (IV) bis(trimethylsilyl),
(t-butylamido)dimethyl(η⁵-2-methyl-3-phenyl-s-indacen-1-yl)silanetitanium (II) 1,4-diphenyl-1,3-butadiene,
(t-butylamido)dimethyl(η⁵-2-methyl-3-phenyl-s-indacen-1-yl)silanetitanium (II) 1,3-pentadiene,
(t-butylamido)dimethyl(η⁵-2-methyl-3-phenyl-s-indacen-1-yl)silanetitanium (III) 2-(N,N-dimethylamino)benzyl,
(t-butylamido)dimethyl(η⁵-2-methyl-3-phenyl-s-indacen-1-yl)silanetitanium (IV) dimethyl,
(t-butylamido)dimethyl(η⁵-2-methyl-3-phenyl-s-indacen-1-yl)silanetitanium (IV) dichloride,
(t-butylamido)dimethyl(η⁵-2-methyl-3-phenyl-s-indacen-1-yl)silanetitanium (IV) bis(trimethylsilyl),
(cyclohexylamido)dimethyl(η⁵-2-methyl-3-phenyl-s-indacen-1-yl)silanetitanium (II) 1,4-diphenyl-1,3-butadiene,
(cyclohexylamido)dimethyl(η⁵-2-methyl-3-phenyl-s-indacen-1-yl)silanetitanium (II) 1,3-pentadiene,
(cyclohexylamido)dimethyl(η⁵-2-methyl-3-phenyl-s-indacen-1-yl)silanetitanium (III) 2-(N,N-dimethylamino)benzyl,
(cyclohexylamido)dimethyl(η⁵-2-methyl-3-phenyl-s-indacen-1-yl)silanetitanium (IV) dimethyl,
(cyclohexylamido)dimethyl(η⁵-2-methyl-3-phenyl-s-indacen-1-yl)silanetitanium (IV) dichloride,
(cyclohexylamido)dimethyl(η⁵-2-methyl-3-phenyl-s-indacen-1-yl)silanetitanium (IV) bis(trimethylsilyl),
(cyclododecylamido)dimethyl(η⁵-2-methyl-3-phenyl-s-indacen-1-yl)silanetitanium (II) 1,4-diphenyl-1,3-butadiene,
(cyclododecylamido)dimethyl(η⁵-2-methyl-3-phenyl-s-indacen-1-yl)silanetitanium (II) 1,3-pentadiene,
(cyclododecylamido)dimethyl(η⁵-2-methyl-3-phenyl-s-indacen-1-yl)silanetitanium (III) 2-(N,N-dimethylamino)benzyl,
(cyclododecylamido)dimethyl(η⁵-2-methyl-3-phenyl-s-indacen-1-yl)silanetitanium (IV) dimethyl,
(cyclododecylamido)dimethyl(η⁵-2-methyl-3-phenyl-s-indacen-1-yl)silanetitanium (IV) dichloride,
(cyclododecylamido)dimethyl(η⁵-2-methyl-3-phenyl-s-indacen-1-yl)silanetitanium (IV) bis(trimethylsilyl),

Other group 4 metal complexes, especially compounds containing other X, Y or Z groups, will, of course, be apparent to those skilled in the art, and are equally suited for use.

The complexes are rendered catalytically active by combination with an activating cocatalyst or use of an activating technique, such as those that are previously known in the art for use with Group 4 metal olefin polymerization complexes. Suitable activating cocatalysts for use herein include polymeric or oligomeric alumoxanes, especially methylalumoxane, triisobutyl aluminum modified methylalumoxane, or isobutylalumoxane; neutral Lewis acids, such as C₁₋₃₀ hydrocarbyl substituted Group 13 compounds, especially tri(hydrocarbyl)aluminum- or tri(hydrocarbyl)boron compounds and halogenated (including perhalogenated) derivatives thereof, having from 1 to 10 carbons in each hydrocarbyl or halogenated hydrocarbyl group, more especially perfluorinated tri(aryl)boron compounds, and most especially tris(pentafluorophenyl)-borane; nonpolymeric, compatible, noncoordinating, ion forming compounds (including the use of such compounds under oxidizing conditions), especially the use of ammonium-, phosphonium-, oxonium-, carbonium-, silylium- or sulfonium-salts of compatible, noncoordinating anions, or ferrocenium salts of compatible, noncoordinating anions; bulk electrolysis (explained in more detail hereinafter); and combinations of the foregoing activating cocatalysts and techniques. A preferred ion forming compound is a tri(C₁₋₂₀-hydrocarbyl)ammonium salt of a tetrakis(fluoroaryl)borate, especially a tetrakis(pentafluorophenyl)borate. The foregoing activating cocatalysts and activating techniques have been previously taught with respect to different metal complexes in the following references: EP-A-277,003, U.S. Pat. No. 5,153,157, U.S. Pat. No. 5,064,802, U.S. Pat. No. 5,321,106, U.S. Pat. No. 5,721,185, U.S. Pat. No. 5,350,723, U.S. Pat. No. 5,425,872, U.S. Pat. No. 5,625,087, U.S. Pat. No. 5,883,204, U.S. Pat. No. 5,919,983, U.S. Pat. No. 5,783,512, WO 99/15534, and U.S. Ser. No. 09/251,664, filed Feb. 17, 1999 (WO99/42467).

Combinations of neutral Lewis acids, especially the combination of a trialkylaluminum compound having from 1 to 4 carbons in each alkyl group and a halogenated tri(hydrocarbyl)boron compound having from 1 to 20 carbons in each hydrocarbyl group, especially tris(pentafluorophenyl)borane, further combinations of such neutral Lewis acid mixtures with a polymeric or oligomeric alumoxane, and combinations of a single neutral Lewis acid, especially tris(pentafluorophenyl)borane with a polymeric or oligomeric alumoxane are especially desirable activating cocatalysts. Preferred molar ratios of Group 4 metal complex:tris(pentafluoro-phenylborane:alumoxane are from 1:1:1 to 1:10:30, more preferably from 1:1:1.5 to 1:5:10.

Suitable ion forming compounds useful as cocatalysts in one embodiment of the present invention comprise a cation which is a Bronsted acid capable of donating a proton, and a compatible, noncoordinating anion, A⁻. As used herein, the term “noncoordinating” means an anion or substance which either does not coordinate to the Group 4 metal containing precursor complex and the catalytic derivative derived therefrom, or which is only weakly coordinated to such complexes thereby remaining sufficiently labile to be displaced by a neutral Lewis base. A noncoordinating anion specifically refers to an anion which when functioning as a charge balancing anion in a cationic metal complex does not transfer an anionic substituent or fragment thereof to said cation thereby forming neutral complexes. “Compatible anions” are anions which are not degraded to neutrality when the initially formed complex decomposes and are noninterfering with desired subsequent polymerization or other uses of the complex.

Preferred anions are those containing a single coordination complex comprising a charge-bearing metal or metalloid core which anion is capable of balancing the charge of the active catalyst species (the metal cation) which may be formed when the two components are combined. Also, said anion should be sufficiently labile to be displaced by olefinic, diolefinic and acetylenically unsaturated compounds or other neutral Lewis bases such as ethers or nitrites. Suitable metals include, but are not limited to, aluminum, gallium, niobium or tantalum. Suitable metalloids include, but are not limited to, boron, phosphorus, and silicon. Compounds containing anions which comprise coordination complexes containing a single metal or metalloid atom are, of course, well known and many, particularly such compounds containing a single boron atom in the anion portion, are available commercially.

Preferably such cocatalysts may be represented by the following general formula:
(L*−H)_{d}⁺(A)^{d-}

wherein:

L* is a neutral Lewis base;

(L*−H)⁺ is a conjugate Bronsted acid of L*;

A^{d-} is a noncoordinating, compatible anion having a charge of d−, and

d is an integer from 1 to 3.

More preferably A^{d-} corresponds to the formula: [M′Q₄]⁻;

wherein:

M′ is boron or aluminum in the +3 formal oxidation state; and

Q independently each occurrence is selected from hydride, dialkylamido, halide, hydrocarbyl, hydrocarbyloxide, halo-substituted hydrocarbyl, halo-substituted hydrocarbyloxy, and halo-substituted silylhydrocarbyl radicals (including perhalogenated hydrocarbyl-perhalogenated hydrocarbyloxy- and perhalogenated silylhydrocarbyl radicals), said Q having up to 20 carbons with the proviso that in not more than one occurrence is Q halide. Examples of suitable hydrocarbyloxide Q groups are disclosed in U.S. Pat. No. 5,296,433.

In a more preferred embodiment, d is one, that is, the counter ion has a single negative charge and is A⁻. Activating cocatalysts comprising boron which are particularly useful in the preparation of catalysts of this invention may be represented by the following general formula:
(L*−H)⁺(BQ₄)⁻;

wherein:

L* is as previously defined;

B is boron in a formal oxidation state of 3; and

Q is a hydrocarbyl-, hydrocarbyloxy-, fluorohydrocarbyl-, fluorohydrocarbyloxy-, hydroxyfluorohydrocarbyl-, dihydrocarbylaluminumoxyfluorohydrocarbyl-, or fluorinated silylhydrocarbyl-group of up to 20 nonhydrogen atoms, with the proviso that in not more than one occasion is Q hydrocarbyl. Most preferably, Q is each occurrence a fluorinated aryl group, especially, a pentafluorophenyl group.

Preferred Lewis base salts are ammonium salts, more preferably trialkyl-ammonium- or dialkylarylammonium-salts containing one or more C₁₂₋₄₀ alkyl groups. The latter cocatalysts have been found to be particularly suitable for use in combination with not only the present metal complexes but other Group 4 metallocenes as well.

Illustrative, but not limiting, examples of boron compounds which may be used as an activating cocatalyst in the preparation of the improved catalysts of this invention (as well as previously known Group 4 metal catalysts) are

tri-substituted ammonium salts such as:
trimethylammonium tetrakis(pentafluorophenyl) borate,
triethylammonium tetrakis(pentafluorophenyl) borate,
tripropylammonium tetrakis(pentafluorophenyl) borate,
tri(n-butyl)ammonium tetrakis(pentafluorophenyl) borate,
tri(sec-butyl)ammonium tetrakis(pentafluorophenyl) borate,
N,N-dimethylanilinium tetrakis(pentafluorophenyl) borate,
N,N-dimethylanilinium n-butyltris(pentafluorophenyl) borate,
N,N-dimethylanilinium benzyltris(pentafluorophenyl) borate,
N,N-dimethylanilinium tetrakis(4-(t-butyldimethylsilyl)-2,3,5,6-tetrafluorophenyl) borate,
N,N-dimethylanilinium tetrakis(4-(triisopropylsilyl)-2,3,5,6-tetrafluorophenyl) borate,
N,N-dimethylanilinium pentafluorophenoxytris(pentafluorophenyl) borate,
N,N-diethylanilinium tetrakis(pentafluorophenyl) borate,
N,N-dimethyl-2,4,6-trimethylanilinium tetrakis(pentafluorophenyl) borate,
dimethyltetradecylammonium tetrakis(pentafluorophenyl) borate,
dimethylhexadecylammonium tetrakis(pentafluorophenyl) borate,
dimethyloctadecylammonium tetrakis(pentafluorophenyl) borate,
methylditetradecylammonium tetrakis(pentafluorophenyl) borate,
methylditetradecylammonium (hydroxyphenyl)tris(pentafluorophenyl) borate,
methylditetradecylammonium (diethylaluminoxyphenyl)tris(pentafluorophenyl) borate,
methyldihexadecylammonium tetrakis(pentafluorophenyl) borate,
methyldihexadecylammonium (hydroxyphenyl)tris(pentafluorophenyl) borate,
methyldihexadecylammonium (diethylaluminoxyphenyl)tris(pentafluorophenyl) borate,
methyldioctadecylammonium tetrakis(pentafluorophenyl) borate,
methyldioctadecylammonium (hydroxyphenyl)tris(pentafluorophenyl) borate,
methyldioctadecylammonium (diethylaluminoxyphenyl)tris(pentafluorophenyl) borate,
methyldioctadecylammonium tetrakis(pentafluorophenyl) borate,
phenyldioctadecylammonium tetrakis(pentafluorophenyl) borate,
phenyldioctadecylammonium (hydroxyphenyl)tris(pentafluorophenyl) borate,
phenyldioctadecylammonium (diethylaluminoxyphenyl)tris(pentafluorophenyl) borate,
(2,4,6-trimethylphenyl)dioctadecylammonium tetrakis(pentafluorophenyl) borate,
(2,4,6-trimethylphenyl)dioctadecylammonium (hydroxyphenyl)tris(pentafluorophenyl)-borate,
(2,4,6-trimethylphenyl)dioctadecylammonium (diethylaluminoxyphenyl)tris(pentafluorophenyl)borate,
(2,4,6-trifluorophenyl)dioctadecylammonium tetrakis(pentafluorophenyl)borate,
(2,4,6-trifluorophenyl)dioctadecylammonium (hydroxyphenyl)tris(pentafluorophenyl)-borate,
(2,4,6-trifluorophenyl)dioctadecylammonium (diethylaluminoxyphenyl)tris(pentafluoro-phenyl) borate,
(pentafluorophenyl)dioctadecylammonium tetrakis(pentafluorophenyl)borate,
(pentafluorophenyl)dioctadecylammonium (hydroxyphenyl)tris(pentafluorophenyl)-borate,
(pentafluorophenyl)dioctadecylammonium (diethylaluminoxyphenyl)tris(pentafluoro-phenyl)borate,
(p-trifluoromethylphenyl)dioctadecylammonium tetrakis(pentafluorophenyl)borate,
(p-trifluoromethylphenyl)dioctadecylammonium (hydroxyphenyl)tris(pentafluoro-phenyl)borate,
(p-trifluoromethylphenyl)dioctadecylammonium (diethylaluminoxyphenyl)tris(penta-fluorophenyl)borate,
p-nitrophenyldioctadecylammonium tetrakis(pentafluorophenyl)borate,
p-nitrophenyldioctadecylammonium (hydroxyphenyl)tris(pentafluorophenyl) borate,
p-nitrophenyldioctadecylammonium (diethylaluminoxyphenyl)tris(pentafluorophenyl)borate,
   and mixtures of the foregoing,

dialkyl ammonium salts such as:
di-(i-propyl)ammonium tetrakis(pentafluorophenyl) borate,
methyloctadecylammonium tetrakis(pentafluorophenyl) borate,
methyloctadodecylammonium tetrakis(pentafluorophenyl) borate, and
dioctadecylammonium tetrakis(pentafluorophenyl) borate;

tri-substituted phosphonium salts such as:
triphenylphosphonium tetrakis(pentafluorophenyl) borate,
methyldioctadecylphosphonium tetrakis(pentafluorophenyl) borate, and
tri(2,6-dimethylphenyl)phosphonium tetrakis(pentafluorophenyl) borate;

di-substituted oxonium salts such as:
diphenyloxonium tetrakis(pentafluorophenyl) borate,
di(o-tolyl)oxonium tetrakis(pentafluorophenyl) borate, and
di(octadecyl)oxonium tetrakis(pentafluorophenyl) borate;

di-substituted sulfonium salts such as:
di(o-tolyl)sulfonium tetrakis(pentafluorophenyl) borate, and
methylcotadecylsulfonium tetrakis(pentafluorophenyl) borate.

Preferred trialkylammonium cations are methyldioctadecylammonium and dimethyloctadecylammonium. The use of the above Bronsted acid salts as activating cocatalysts for addition polymerization catalysts is known in the art, having been disclosed in U.S. Pat. Nos. 5,064,802, 5,919,983, 5,783,512 and elsewhere. Preferred dialkylarylammonium cations are fluorophenyldioctadecylammonium-, perfluoro-phenyldioctacecylammonium- and p-trifluoromethylphenyldi(octadecyl)ammonium cations. It should be noted that certain of the cocatalysts, especially those containing a hydroxyphenyl ligand in the borate anion, may require the addition of a Lewis acid, especially a trialkylaluminum compound, to the polymerization mixture or the catalyst composition, in order to form the active catalyst composition.

Another suitable ion forming, activating cocatalyst comprises a salt of a cationic oxidizing agent and a noncoordinating, compatible anion represented by the formula:
(Ox^{e+})_{d}(A^{d-})ₑ.
wherein:

Ox^{e+} is a cationic oxidizing agent having a charge of e+;

e is an integer from 1 to 3; and

A^{d-} and d are as previously defined.

Examples of cationic oxidizing agents include: ferrocenium, hydrocarbyl-substituted ferrocenium, Ag⁺, or Pb⁺². Preferred embodiments of A^{d-} are those anions previously defined with respect to the Bronsted acid containing activating cocatalysts, especially tetrakis(pentafluorophenyl)borate. The use of the above salts as activating cocatalysts for addition polymerization catalysts is known in the art, having been disclosed in U.S. Pat. No. 5,321,106.

Another suitable ion forming, activating cocatalyst comprises a compound which is a salt of a carbenium ion and a noncoordinating, compatible anion represented by the formula:
Cb⁺A⁻

wherein:

Cb⁺ is a C₁₋₂₀ carbenium ion; and

A⁻ is as previously defined. A preferred carbenium ion is the trityl cation, that is triphenylmethylium. The use of the above carbenium salts as activating cocatalysts for addition polymerization catalysts is known in the art, having been disclosed in U.S. Pat. No. 5,350,723.

A further suitable ion forming, activating cocatalyst comprises a compound which is a salt of a silylium ion and a noncoordinating, compatible anion represented by the formula:
R³₃Si(X′)_{q}⁺A⁻

wherein:

R³ is C₁₋₁₀ hydrocarbyl, and X′, q and A⁻ are as previously defined.

Preferred silylium salt activating cocatalysts are trimethylsilylium tetrakispentafluorophenylborate, triethylsilylium tetrakispentafluorophenylborate and ether substituted adducts thereof. The use of the above silylium salts as activating cocatalysts for addition polymerization catalysts is known in the art, having been disclosed in U.S. Pat. No. 5,625,087.

Certain complexes of alcohols, mercaptans, silanols, and oximes with tris(pentafluorophenyl)borane are also effective catalyst activators and may be used according to the present invention. Such cocatalysts are disclosed in U.S. Pat. No. 5,296,433.

Another class of suitable catalyst activators are expanded anionic compounds corresponding to the formula: (A^{1+a}^{¹})_{b}_{¹}(Z¹J¹ⱼ_{¹})^{-c1}_{d}_{¹}, wherein:

A¹ is a cation of charge +a¹,

Z¹ is an anion group of from 1 to 50, preferably 1 to 30 atoms, not counting hydrogen atoms, further containing two or more Lewis base sites;

J¹ independently each occurrence is a Lewis acid coordinated to at least one Lewis base site of Z¹, and optionally two or more such J¹ groups may be joined together in a moiety having multiple Lewis acidic functionality,

j¹ is a number from 2 to 12 and

a¹, b¹, c¹, and d¹ are integers from 1 to 3, with the proviso that a¹×b¹ is equal to c¹×d¹.

The foregoing cocatalysts (illustrated by those having imidazolide, substituted imidazolide, imidazolinide, substituted imidazolinide, benzimidazolide, or substituted benzimidazolide anions) may be depicted schematically as follows:

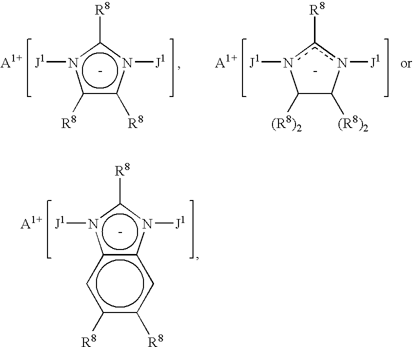

wherein:

A¹⁺ is a monovalent cation as previously defined, and preferably is a trihydrocarbyl ammonium cation, containing one or two C₁₀₋₄₀ alkyl groups, especially the methylbis(tetradecyl)ammonium- or methylbis(octadecyl)ammonium-cation,

R⁸, independently each occurrence, is hydrogen or a halo, hydrocarbyl, halocarbyl, halohydrocarbyl, silylhydrocarbyl, or silyl, (including mono-, di- and tri(hydrocarbyl)silyl) group of up to 30 atoms not counting hydrogen, preferably C₁₋₂₀ alkyl, and

J¹ is tris(pentafluorophenyl)borane or tris(pentafluorophenyl)aluminane.

Examples of these catalyst activators include the trihydrocarbylammonium-, especially, methylbis(tetradecyl)ammonium- or methylbis(octadecyl)ammonium-salts of:
bis(tris(pentafluorophenyl)borane)imidazolide,
bis(tris(pentafluorophenyl)borane)-2-undecylimidazolide,
bis(tris(pentafluorophenyl)borane)-2-heptadecylimidazolide,
bis(tris(pentafluorophenyl)borane)-4,5-bis(undecyl)imidazolide,
bis(tris(pentafluorophenyl)borane)-4,5-bis(heptadecyl)imidazolide,
bis(tris(pentafluorophenyl)borane)imidazolinide,
bis(tris(pentafluorophenyl)borane)-2-undecylimidazolinide,
bis(tris(pentafluorophenyl)borane)-2-heptadecylimidazolinide,
bis(tris(pentafluorophenyl)borane)-4,5-bis(undecyl)imidazolinide,
bis(tris(pentafluorophenyl)borane)-4,5-bis(heptadecyl)imidazolinide,
bis(tris(pentafluorophenyl)borane)-5,6-dimethylbenzimidazolide,
bis(tris(pentafluorophenyl)borane)-5,6-bis(undecyl)benzimidazolide,
bis(tris(pentafluorophenyl)alumane)imidazolide,
bis(tris(pentafluorophenyl)alumane)-2-undecylimidazolide,
bis(tris(pentafluorophenyl)alumane)-2-heptadecylimidazolide,
bis(tris(pentafluorophenyl)alumane)-4,5-bis(undecyl)imidazolide,
bis(tris(pentafluorophenyl)alumane)-4,5-bis(heptadecyl)imidazolide,
bis(tris(pentafluorophenyl)alumane)imidazolinide,
bis(tris(pentafluorophenyl)alumane)-2-undecylimidazolinide,
bis(tris(pentafluorophenyl)alumane)-2-heptadecylimidazolinide,
bis(tris(pentafluorophenyl)alumane)-4,5-bis(undecyl)imidazolinide,
bis(tris(pentafluorophenyl)alumane)-4,5-bis(heptadecyl)imidazolinide,
bis(tris(pentafluorophenyl)alumane)-5,6-dimethylbenzimidazolide, and
bis(tris(pentafluorophenyl)alumane)-5,6-bis(undecyl)benzimidazolide.

A further class of suitable activating cocatalysts include cationic Group 13 salts corresponding to the formula:
[M″Q¹₂L′_{1′}]⁺(Ar^{f}₃M′Q²)⁻

wherein:

M″ is aluminum, gallium, or indium;

M′ is boron or aluminum;

Q¹ is C₁₋₂₀ hydrocarbyl, optionally substituted with one or more groups which independently each occurrence are hydrocarbyloxy, hydrocarbylsiloxy, hydrocarbylsilylamino, di(hydrocarbylsilyl)amino, hydrocarbylamino, di(hydrocarbyl)amino, di(hydrocarbyl)phosphino, or hydrocarbylsulfido groups having from 1 to 20 atoms other than hydrogen, or, optionally, two or more Q¹ groups may be covalently linked with each other to form one or more fused rings or ring systems;

Q² is an alkyl group, optionally substituted with one or more cycloalkyl or aryl groups, said Q² having from 1 to 30 carbons;

L′ is a monodentate or polydentate Lewis base, preferably L′ is reversibly coordinated to the metal complex such that it may be displaced by an olefin monomer, more preferably L′ is a monodentate Lewis base;

1′ is a number greater than zero indicating the number of Lewis base moieties, L′, and

Ar^{f} independently each occurrence is an anionic ligand group; preferably Ar^{f} is selected from the group consisting of halide, C₁₋₂₀ halohydrocarbyl, and Q¹ ligand groups, more preferably Ar^{f} is a fluorinated hydrocarbyl moiety of from 1 to 30 carbon atoms, most preferably Ar^{f} is a fluorinated aromatic hydrocarbyl moiety of from 6 to 30 carbon atoms, and most highly preferably Ar^{f} is a perfluorinated aromatic hydrocarbyl moiety of from 6 to 30 carbon atoms.

Examples of the foregoing Group 13 metal salts are alumicinium tris(fluoroaryl)borates or gallicinium tris(fluoroaryl)borates corresponding to the formula: [M″Q¹₂L′_{1′}]⁺(Ar^{f}₃BQ²)⁻, wherein M″ is aluminum or gallium; Q¹ is C₁₋₂₀ hydrocarbyl, preferably C₁₋₈ alkyl; Ar^{f} is perfluoroaryl, preferably pentafluorophenyl; and Q² is C₁₋₈ alkyl, preferably C₁₋₈ alkyl. More preferably, Q¹ and Q² are identical C₁₋₈ alkyl groups, most preferably, methyl, ethyl or octyl.

The foregoing activating cocatalysts may also be used in combination. An especially preferred combination is a mixture of a tri(hydrocarbyl)aluminum or tri(hydrocarbyl)borane compound having from 1 to 4 carbons in each hydrocarbyl group or an ammonium borate with an oligomeric or polymeric alumoxane compound.

The molar ratio of catalyst/cocatalyst employed preferably ranges from 1:10,000 to 100:1, more preferably from 1:5000 to 10:1, most preferably from 1:1000 to 1:1. Alumoxane, when used by itself as an activating cocatalyst, is employed in large quantity, generally at least 100 times the quantity of metal complex on a molar basis. Tris(pentafluorophenyl)borane, where used as an activating cocatalyst is employed in a molar ratio to the metal complex of from 0.5:1 to 10:1, more preferably from 1:1 to 6:1 most preferably from 1:1 to 5:1. The remaining activating cocatalysts are generally employed in approximately equimolar quantity with the metal complex.

The attainment of high polymerization efficiency, especially high conversion (greater than 90 percent) of diene is an especially desirable feature of the present process. High conversion efficiency results in better homogeneity in the resulting product as well as decreased costs due to the need to recycle unreacted monomer. For purposes of determining conversion herein, the appropriate measure is the ratio of the mass of the substance contained in the recycle stream compared to the quantity of such material added to the reactor. As an aid in obtaining increased diene conversion the presence of a hindered phenol, especially 2,6-ditertiarybutylphenol in the reaction mixture is desirable. The hindered phenol is desirable added along with any one or all of the monomers, catalysts or other reagents, such as the group 4 metal complex or activator added to the reactor. Although the benefits of the present invention are obtainable without the use of a support, the skilled artisan will appreciate that a support, especially dehydrated silica, or a spray dried solid version of the present catalyst may be employed in the present process as well.

It is understood that the present invention is operable in the absence of any component which has not been specifically disclosed. The following examples are provided in order to further illustrate the invention and are not to be construed as limiting. Unless stated to the contrary, all parts and percentages are expressed on a weight basis.

### EXAMPLES

The reactor used in the polymerizations is a two-phase (gas/solid) stirred bed, back mixed reactor operating in batch mode. A set of four plows mounted horizontally on a central shaft rotate at 200 rpm to keep the particles in the reactor mechanically fluidized. The cylinder swept by these plows measures 40.6 cm long by 39.7 cm in diameter, resulting in a mechanically fluidizable volume of 45 liters. The gas volume, larger than the mechanically fluidizable volume due to the vertical cylindrical chamber plus other ancillary equipment in the reaction system, totals 62.6 liters.

Reactor pressure used is typically 350 psig (2.4 MPa). Ethylene, propylene and diene monomers are fed to the reactor continuously via control valves. Partial pressures of monomers range typically, for ethylene 240 to 320 psig (1.7-2.2 MPa) and for propylene 35 to 90 psig (240 to 620 kPa). Gas composition is measured by a gas chromatograph analyzer. Nitrogen makes up the balance of the composition of the gas, entering with the catalyst and leaving via a small vent of the reactor gases. Vent opening is adjusted via computer to maintain constant total pressure in the reactor. The amount of diene fed varies from 14 to 23 ml/kg of polymer produced.

The reactor is cooled by an external jacket of ethylene glycol. The bed temperature is measured with a temperature probe in a thermowell protruding into the bed. The catalyst solution is continuously pressured into the reactor by nitrogen. Cocatalysts are also added continuously, at fixed molar ratios to the catalyst feed rate. Carbon black N-650 fluidization aid is added to the reactor at the beginning of the polymerization in an amount from 10 to 20 percent. A trialkylaluminum compound or alumoxane is added to passivate Lewis base sites on the fluidization aid. Typical runs last 2 to 10 hours and produce from 2 to 5 Kg of polymer.

A typical run commences by charging the reactor with carbon black flow aid (N-650, available from Columbian Inc.) and passivating agent. Stirring is commenced and nitrogen and monomer feeds adjusted until the desired gas composition is reached. Catalyst addition is begun and monomer feeds are adjusted to maintain the desired concentration. When the polymer production rate reaches 1.5 to 4.4 Kg/hr, catalyst and cocatalyst feed rates are reduced to maintain a constant polymer production rate. After the desired quantity of polymer is produced, the monomers are purged, the catalyst is deactivated with isopropanol, and the polymer is stabilized by addition of a mixture of hindered phenol (butylated hydroxytoluene) and zinc oxide. A nitrogen purge is used to remove residual diene.

The Mooney viscosity of the resulting product (Product Mooney) was measured by massing the polymer particles to remove air and to disperse the flow aid and then measuring the Mooney Viscosity of the product according to ASTM D1646 for ML 1+4 at 125° C.±0.5° C. A correction factor was then applied to determine the viscosity attributable to the polymer in the absence of flow aid (Polymer Mooney) as follows:

$$Polymer Mooney = 56.55 + 34.65 [ \frac{Product Mooney - 59.9164 - 10.86981 ( \frac{CB - 17.5}{17.5} )}{38.419775 + 4.234426 ( \frac{CB - 17.5}{17.5} )} ]$$

Where CB is the carbon black content in percent.

### Example 1

Dry carbon black (1 Kg) was charged into the stirred bed reactor and passivated with methylalumoxane (MMAO, 0.2 mmol/g). Ethylene (1.65 MPa) and propylene in a molar ratio ethylene/propylene of 0.2 were charged and the reactor heated to 60° C. Ethylidenenorbornene (ENB) flow was begun at an initial rate of 15 ml/hr. Catalyst ((t-butylamido)dimethyl-(tetramethylcyclopentadienyl)silanetitanium dichloride, ACT) in hexane (0.001 M) was precontacted with 10 percent MMAO in isopentane inline for 10 min at an Al/Ti molar ratio of 740 and then passed into the reactor. When the polymerization rate was steady all monomer levels were maintained by continuous flow of these components. After 6.7 hours, the reaction was terminated, resulting in production of 4.4 Kg of polymer.

The polymer composition was found to be 35 percent propylene, 7.9 percent ENB and 57.1 percent ethylene. The Ti residue in the polymer was 6.4 ppm. The product had a Polymer Mooney viscosity of 77 with no detectable level of crystallinity.

### Example 2

The reaction conditions of Example 1 are substantially repeated excepting that the cocatalyst and catalyst were fed at an Al/Ti molar ratio of 400. After 6.5 hours, the reaction was terminated resulting in the production of 2.5 Kg of EPDM polymer comprising 33 percent propylene, 11.7 percent ENB and 55.3 percent ethylene. The Ti residue in the polymer was 13.1 ppm. The product had a Polymer Mooney viscosity of 49 with no detectable level of crystallinity.

### Example 3

The reaction conditions of Example 1 were substantially repeated excepting that 1.2 Kg of carbon black was used, the cocatalyst and catalyst were fed at an Al/Ti molar ratio of 430, and hydrogen (0.1 mole percent based on ethylene) was continuously added to the reactor. After 9.5 hours reaction time, the reaction was terminated resulting in recover of 6 Kg of EPDM polymer containing 36 percent propylene, 6.7 percent ENB and 57.3 percent ethylene. The Ti residue was 4.8 ppm. The product had a Polymer Mooney viscosity of 63 and no detectable level of crystallinity.

### Example 4

The reaction conditions of Example 1 were substantially repeated excepting that the ethylene/propylene ratio was 0.3, the reactor was maintained at 75° C. The catalyst was prepared by combining pentamethylcyclopentadienyltitanium trichloride with 4 equivalents of methanol in toluene to give a titanium concentration of 6.4 mmole/L. This catalyst solution was contacted with a mixture of methylalumoxane (9 percent) and 2,6 di-tertiary-butylphenol (7 percent) in toluene inline for 10 min and then passed into the reactor at a steady rate in an Al/Ti ratio of 920. After 6 hours, the reaction was terminated resulting in production of 4.7 Kg of EPDM polymer having a composition of 29.2 percent propylene, 8.2 percent ENB and 62.6 percent ethylene. The Ti residue in the polymer was 8.9 ppm and it contained 21 percent carbon black. The product had a Polymer Mooney viscosity of 87 and a crystallinity of 0.7 percent.

### Example 5

The reaction conditions of Example 4 were substantially repeated excepting that the ethylene/propylene ratio was 0.4, the reactor was maintained at 60° C., the catalyst solution was prepared by contacting pentamethylcyclopentadienyltitanium trichloride with 4 equivalents of methanol and 100 equivalents of 2,6 di-tertiary butyl phenol in toluene to give a concentration of 0.0064 M. This solution was contacted with methyl alumoxane (9 percent in toluene) inline for 10 min and then passed into the reactor. The Al/Ti ratio of cocatalyst and catalyst fed to the reactor was 224. After 8 hours, the reaction was terminated and 6.0 Kg of EPDM polymer recovered. The product contained 41.6 percent propylene, 6.2 percent ENB and 52.2 percent ethylene. The Ti residue was 13.4 ppm. The product had a Polymer Mooney viscosity of 59, contained 14 percent carbon black and had a crystallinity of 0.2 percent. Peak recrystallization temperature (a property affected by the degree of crystallinity) was −27° C.

### Example 6

The reaction conditions of Example 5 were substantially repeated excepting that the cocatalyst and catalyst were fed at a Al/Ti ratio of 150. After 7 hours, the reaction was terminated and 4.5 Kg of product was recovered. The polymer composition was found to be 37.6 percent propylene, 4.0 percent ENB and 58.4 percent ethylene. The Ti residue in the polymer was 19.5 ppm. The Polymer Mooney viscosity of the product was 75. It contained 20 percent carbon black with a crystallinity of 0.3 percent. Peak recrystallization temperature is −32° C.

### Examples 7 to 12

In the following examples the polymerization was conducted in a fluid bed reactor as depicted in FIG. 1. The reactor had a lower section 3 M high and 0.34 M in inner diameter and an upper section which was 4.9 M high and 0.6 M in inner diameter. Reactions were conducted at 65° C. and total reactor pressure of 2.6 Mpa, with injected catalyst (t-butylamido)dimethyl (tetramethylcyclopentadienyl)titanium dichloride 0.02 M in toluene) and reaction conditions and results as indicated in the following table. The cocatalyst used was MMAO. DTBP stands for ditertiarybutylphenol. FTIR stands for “Fourier Transform Infrared Spectroscopy”. APS stands for “average particle size”. The catalyst injectors were protected by flowing nitrogen shroud gas. Carbon black flow aid (N-650) was used in all examples.

| Example | | | | | |
|---|---|---|---|---|---|
| 7 | 8 | 9 | 10 | 11 | 12 |

Process Conditions

| | | | | | | |
|---|---|---|---|---|---|---|
| ethylene partial pressure MPa | 1.6 | 1.6 | 1.6 | 1.65 | 1.65 | 1.65 |
| C3/C2 | 0.12 | 0.12 | 0.12 | 0.15 | 0.15 | 0.20 |
| H2/C2 | 0.0040 | 0.0040 | 0.0040 | 0.0020 | 0.0005 | 0.0045 |
| ENB ppmv (gas phase) | 69 | 53 | 65 | 92 | 92 | 238 |
| Bed Weight (kg) | 54 | 54 | 54 | 54 | 54 | 54 |
| Fluidized Bulk Density (kg/m3) | 232.0 | 246.0 | 250.0 | 290.0 | 227.0 | 259.0 |
| Superficial Gas Velocity (m/sec) | 0.46 | 0.43 | 0.45 | 0.48 | 0.43 | 0.43 |
| Total Production Rate (kg/hr) | 9.2 | 11 | 9.8 | 10.4 | 13.2 | 9.4 |
| Catalyst feed nozzle orifice size (mm) | 0.5 | 0.5 | 0.5 | 0.76 | 0.76 | 0.76 |
| N2 atomizing gas flow (kg/hr) | 1.4 | 1.4 | 1.4 | 1.8 | 1.4 | 1.8 |
| support tube gas | none | none | none | none | none | none |
| support tube gas flow (kg/hr) | n/a | n/a | n/a | n/a | n/a | n/a |
| Cycle gas shroud gas flow (kg/hr) | 326 | 316 | 340 | 0 | 0 | 0 |
| Catalyst flow rate (cc/hr) | 52 | 48 | 50 | 39 | 37 | 50 |
| 7.1 percent Al MMAO Flow (cc/hr) | 110 | 119 | 115 | 105 | 103 | 104 |
| Al/Ti molar Ratio | 178 | 208 | 194 | 224 | 231 | 175 |
| 10 percent DTBP Flow (cc/hr) | na | 56 | 69 | na | na | na |
| ENB flow (cc/hr) | 0.99 | 0.93 | 1.02 | 545.82 | 698.85 | 1137.55 |
| ENB Efficiency (percent) | 79% | 89% | 75% | 74% | 84% | 63% |

Post Reaction Treatment

| | | | | | | |
|---|---|---|---|---|---|---|
| Quench Type | MeOH | MeOH | MeOH | MeOH | MeOH | MeOH |
| Quench Flow (cc/hr) | 100 | 100 | 100 | 201 | 200 | 99 |
| Quench/Al mol ratio | 13.4 | 12.4 | 12.8 | 28.2 | 28.6 | 14.0 |
| Purging Peak Temp. (° C.) | 78 | 74 | 76 | 81 | 81 | 81 |
| Purging Time at Peak Temp. (hrs) | 4 | 4.5 | 6 | 4 | 3 | 5 |
| Total Purging Time (hrs) | 6 | 6 | 6 | 6 | 6 | 6 |

Composition and Mooney

| | | | | | | |
|---|---|---|---|---|---|---|
| C2 (Calc.) | 65.8 | 67.8 | 66.5 | 62.7 | 62.9 | 55.7 |
| C3 weight percent (FTIR) | 29.2 | 28 | 29 | 32.3 | 32 | 35.2 |
| ENB weight percent (FTIR) | 5 | 4.2 | 4.5 | 5 | 5.1 | 9.1 |
| Polymer Mooney | 82 | 83 | 81 | 150 | 200 | 79 |
| Carbon Black (percent) | 29 | 24 | 27 | 45 | 28 | 34.1 |
| Ti, ppm (polymer basis) | 6.6 | 5.6 | 5.8 | 5.2 | 3.5 | 6.8 |

APS & Granular Character

| | | | | | | |
|---|---|---|---|---|---|---|
| Bulk Density, (kg/m3) | 408.5 | 413.3 | 411.7 | 440.6 | 435.7 | 440.6 |
| APS, (mm) | 0.767 | 0.759 | 0.841 | 0.77 | 1.534 | 0.864 |
| Agglomerates, >#6 mesh, (percent) | 0.71 | 0.89 | 1.17 | 4.11 | 16.03 | 3.35 |
| Mass, >#10 mesh, (percent) | 2.61 | 4.25 | 4.56 | 4.56 | 10.14 | 4.58 |
| Mass, >#18 mesh, (percent) | 16.19 | 15.86 | 19.09 | 10.17 | 16.55 | 15.65 |
| Mass, >#35 mesh, (percent) | 43.68 | 32.17 | 36.16 | 21.17 | 21.32 | 30.08 |
| Mass, >#60 mesh, (percent) | 32.86 | 37.82 | 35.57 | 39.64 | 27.04 | 37.73 |
| Mass, >#120 mesh, (percent) | 2.76 | 5.58 | 2.15 | 3.37 | 2.25 | 3.28 |
| Pan Fines, <#120 mesh, (percent) | 1.18 | 3.43 | 1.3 | 16.98 | 6.67 | 5.33 |

Crystallinity

| | | | | | | |
|---|---|---|---|---|---|---|
| Total Crystallinity, (percent) | 1.36 | 1.66 | 1.37 | 0.22 | 0.28 | 0.12 |
| Glass Transition - Inflection, ° C. | −38.9 | −37.42 | −40.8 | −43.29 | −44.19 | −43.63 |
| Cooling Scan, Joules/g | 23.76 | 25.8 | 23.18 | 11.67 | 13.98 | 5.22 |
| Peak Temp. Cooling Scan, ° C. | 16.04 | 17.15 | 16.63 | 4.84 | 4.08 | −23.7 |

1-16. (canceled)

17. A process for producing an elastomeric polymer particles in a gas phase polymerization reaction, said process comprising:
a) introducing one or more polymerizable monomers, comprising one or more conjugated or nonconjugated diene monomers having from 4 to 20 carbons, into a reactor, operating under gas phase polymerization conditions, at a temperature of at least 50° C.;
b) introducing into said reactor a flow aid material that is capable of preventing substantial formation of polymer particle agglomerates, and wherein the flow aid is a solid particulate;
c) introducing into said reactor a polymerization catalyst mixture, comprising a group 4 metal complex containing at least one cyclic ligand, containing delocalized π-electrons, and corresponding to the formula: 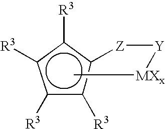
wherein,
M is titanium or zirconium in the +2, +3 or +4 formal oxidation state;
R³, in each occurrence, independently is selected from the group consisting of hydrogen, hydrocarbyl, silyl, germyl, cyano, halo and combinations thereof, said R³ having up to 20 non-hydrogen atoms, or adjacent R³ groups together form a divalent derivative, thereby forming a fused ring system,
each X is chloride, hydride, or a hydrocarbyl hydrocarbyloxy, or trihydrocarbylsilyl group, or a dihydrocarbylamino-, hydrocarbyleneamino-, hydrocarbyloxy-, or trihydrocarbylsilyl-substituted derivative thereof, said group or substituted group having up to 30 non-hydrogen atoms, or two X groups together form a neutral C₄₋₆₀ conjugated diene or a divalent derivative thereof;
x is 1 or 2 selected to provide charge balance;
Y is —O—, —S—, —NR*—, —PR*—;
Z is SiR*₂, CR*₂, SiR*₂SiR*₂, CR*₂CR*₂, CR*═CR*, CR*₂SiR*₂, SnR*₂, or GeR*₂, wherein R* is hydrogen, or C₁₋₁₀ hydrocarbyl;
and a cocatalyst therefor into said reactor;
and wherein said steps a), b) and c) occur in any order, two together, or all three simultaneously; and
d) withdrawing a polymer product from the reactor in the form of free flowing polymer particles.

18. The process of claim 17, wherein the metal complex corresponds to the formula: 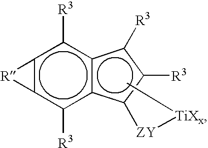
wherein R³, in each occurrence, independently is selected from the group consisting of hydrogen, hydrocarbyl, silyl, germyl, cyano, halo and combinations thereof, said R³ having up to 20 non-hydrogen atoms, or adjacent R³ groups together form a divalent derivative thereby forming a fused ring system;
each X is chloride, hydride or a hydrocarbyl, hydrocarbyloxy, or trihydrocarbylsilyl group, or a dihydrocarbylamino-, hydrocarbyleneamino-, hydrocarbyloxy-, or trihydrocarbylsilyl-substituted derivative thereof, said group or substituted group having up to 30 non-hydrogen atoms, or two X groups together form a neutral C₄₋₆₀ conjugated diene or a divalent derivative thereof;
x is 1 or 2, selected to provide charge balance;
Y is —O—, —S—, —NR*—, —PR*—;
Z is SiR*₂, CR*₂, SiR*₂SiR*₂, CR*₂CR*₂, CR*═CR*, CR*₂SiR*₂, SnR*₂, or GeR*₂, wherein R* is hydrogen, or C₁₋₁₀ hydrocarbyl; and
R″ is a divalent hydrocarbylene- or substituted hydrocarbylene group forming a fused system, with the remainder of the metal complex, said R″ containing from 1 to 30 nonhydrogen atoms.

19. The process claim 17, wherein a hindered phenol is introduced into the reactor.

20. The process claim 19, wherein a hindered phenol is introduced into the reactor in step c), along with the polymerization catalyst.

21. The process of claim 19, wherein the hindered phenol is 2,6-ditertiarybutylphenol.

22. The process of claim 17, wherein one or more conjugated or non-conjugated diene monomers having from 4 to 20 carbon atoms, ethylene, and one or more C₃₋₈ α-olefins are polymerized into an elastomeric polymer.

23. The process of claim 17, wherein the polymer has a Mooney viscosity of at least 100.

24. The process of claim 19, wherein the polymer has a Mooney viscosity of at least 100.

25. The process of claim 17, wherein the polymer has a crystallinity less than 1.5 percent.

26. The process of claim 17, wherein the flow aid is selected from carbon black, clay and silicon treated derivatives thereof.

27. The process of claim 25, wherein the flow aid is carbon black.

28. The process of claim 19, wherein the flow aid is selected from carbon black, clay, or silicon treated derivatives thereof.

29. The process of claim 28, wherein the flow aid is carbon black.

30. The process of claim 17, wherein the catalyst and cocatalyst composition is supplied to the reaction zone of the reactor in the form of a liquid.

31. The process of claim 17, wherein the reactor is a gas phase, fluidized bed reactor.

32. The process of claim 19, wherein the reactor is a gas phase, fluidized bed reactor.

33. The process of claim 17, wherein one or more conjugated or non-conjugated diene monomers having from 4 to 20 carbon atoms is polymerized in a conversion efficiency greater than 90 percent.

34. The process of claim 19, wherein one or more conjugated or non-conjugated diene monomers having from 4 to 20 carbon atoms is polymerized in a conversion efficiency greater than 90 percent.

35. The process of claim 17, wherein the group 4 metal complex corresponds to the formula: 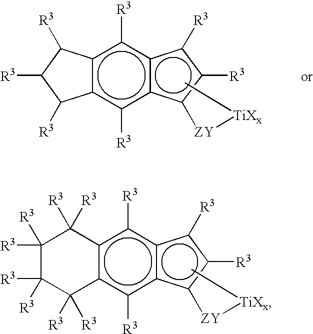
and wherein R³, X, Y, Z and x are as previously defined in claim 1.

36. The process of claim 17, wherein the catalyst composition comprises ethylbenzene.
